(19) United States
(12) Patent Application Publication
(10) Pub. No.: US 2026/0333346 A1
(43) Pub. Date: Oct. 22, 2026

(54) METHOD AND DEVICE FOR REDUCING OVERHEAD OF DOWNLINK CONTROL INFORMATION DURING MULTI-CELL SCHEDULING IN WIRELESS COMMUNICATION SYSTEM

(71) Applicant: Samsung Electronics Co., Ltd., Gyeonggi-do (KR)

(72) Inventors: Youngrok JANG, Gyeonggi-do (KR); Youngbum KIM, Gyeonggi-do (KR); Seongmok LIM, Gyeonggi-do (KR); Hyoungju JI, Gyeonggi-do (KR); Kyungjun CHOI, Gyeonggi-do (KR)

(21) Appl. No.: 19/481,739

(22) PCT Filed: May 7, 2024
(86) PCT No.: PCT/KR2024/006095

§ 371 Date: Nov. 5, 2025

(30) Foreign Application Priority Data
May 10, 2023 (KR) 10-2023-0060609

(51) Int. Cl. H04W 72/1268; H04L 5/00; H04W 72/0453; H04W 72/231

(52) U.S. Cl. CPC H04W 72/1268; H04L 5/0044; H04W 72/0453; H04W 72/231

(57) ABSTRACT

The present disclosure relates to a 5G or 6G communication system for supporting higher data transmission rates. Specifically, the present disclosure relates to a method for transmitting and receiving an uplink data channel through MC-DCI and a device capable of performing same in a wireless communication system. The present disclosure provides a device and method capable of effectively providing services in a mobile communication system.

### TECHNICAL FIELD

The disclosure relates to operations of a terminal and a base station in a wireless communication system. Specifically, the disclosure relates to a method for reducing overhead of downlink control information during multi-cell scheduling in a wireless communication system and a device capable of performing same.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (e.g., 95 GHz to 3THz bands) in order to accomplish transmission rates fifty times faster than 5G mobile communication technologies and ultra-low latencies one-tenth of 5G mobile communication technologies.

In the initial stage of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Moreover, a study is being made of a technology for effectively scheduling data transmission/reception through multi-cell scheduling.

### DISCLOSURE

### Technical Problem

Embodiments set forth herein are to provide a device and a method capable of effectively providing services in a mobile communication system. Specifically, a method and a device for reducing the overhead of downlink control information are proposed.

### Technical Solution

A method performed by a terminal in a communication system, for achieving the issues described above, includes: receiving, from a base station, information for configuring uplink data transmission supporting up to 8 layers, receiving, from the base station, information for configuring dynamic waveform switching for a physical uplink shared channel (PUSCH); receiving, from the base station, downlink control information (DCI) for scheduling the uplink data transmission, the DCI including scheduling information for the PUSCH and a waveform switching indicator for the PUSCH; and based on the DCI, transmitting the PUSCH to the base station, wherein the scheduling information includes frequency resource allocation information for the PUSCH, a value of the frequency resource allocation information indicates one number among multiples of one or more predetermined integers, and as many consecutive resource blocks as a number corresponding to the one number are scheduled.

In addition, a method performed by a base station in a communication system includes: transmitting, to a terminal, information for configuring uplink data transmission supporting up to 8 layers; transmitting, to the terminal, information for configuring dynamic waveform switching for a physical uplink shared channel (PUSCH): transmitting, to the terminal, downlink control information (DCI) for scheduling the uplink data transmission, the DCI including scheduling information for the PUSCH and a waveform switching indicator for the PUSCH; and receiving the PUSCH corresponding to the DCI from the terminal, wherein the scheduling information includes frequency resource allocation information for the PUSCH, a value of the frequency resource allocation information indicates one number among multiples of one or more predetermined integers, and as many consecutive resource blocks as a number corresponding to the one number are scheduled.

In addition, a terminal in a communication system includes a transceiver, and a controller configured to: receive, from a base station, information for configuring uplink data transmission supporting up to 8 layers; receive, from the base station, information for configuring dynamic waveform switching for a physical uplink shared channel (PUSCH); receive, from the base station, downlink control information (DCI) for scheduling the uplink data transmission, the DCI including scheduling information for the PUSCH and a waveform switching indicator for the PUSCH; and based on the DCI, transmit the PUSCH to the base station, wherein the scheduling information includes frequency resource allocation information for the PUSCH, a value of the frequency resource allocation information indicates one number among multiples of one or more predetermined integers, and as many consecutive resource blocks as a number corresponding to the one number are scheduled.

In addition, a base station in a communication system includes a transceiver, and a controller configured to: transmit, to a terminal, information for configuring uplink data transmission supporting up to 8 layers; transmit, to the terminal, information for configuring dynamic waveform switching for a physical uplink shared channel (PUSCH); transmit, to the terminal, downlink control information (DCI) for scheduling the uplink data transmission, the DCI including scheduling information for the PUSCH and a waveform switching indicator for the PUSCH; and receive the PUSCH corresponding to the DCI from the terminal, wherein the scheduling information includes frequency resource allocation information for the PUSCH, a value of the frequency resource allocation information indicates one number among multiples of one or more predetermined integers, and as many consecutive resource blocks as a number corresponding to the one number are scheduled.

### Advantageous Effects

Embodiments set forth herein provide a device and a method capable of effectively providing services in a mobile communication system. Specifically, transmission/reception of control information can be effectively performed by reducing the overhead of downlink control information.

### DESCRIPTION OF DRAWINGS

FIG. 1 illustrates a basic structure of a time-frequency domain, which is a radio resource domain used to transmit data or control channels, in a 5G system.

FIG. 2 illustrates an example of a structure of a frame, a subframe, and a slot in a 5G system.

FIG. 3 illustrates an example of a bandwidth part configuration in a 5G system.

FIG. 4 illustrates an example of base station beam allocation according to a TCI state configuration in a 5G system.

FIG. 5 illustrates an example of a control resource set (CORESET) used to transmit a downlink control channel in a 5G system.

FIG. 6 illustrates an example of a basic unit of time and frequency resources constituting a downlink control channel available in a 5G system.

FIG. 7 illustrates an example of frequency domain resource assignment with regard to a PDSCH or PUSCH in a wireless communication system according to an embodiment of the disclosure.

FIG. 8 illustrates a VRB-PRB interleaving scheme of a PDSCH during FDRA type-1 resource allocation according to an embodiment of the disclosure.

FIG. 9 illustrates an example of time domain resource allocation with regard to a PDSCH in a wireless communication system according to an embodiment of the disclosure.

FIG. 10 illustrates an example of MC-DCI including multiple FDRA fields according to an embodiment of the disclosure.

FIG. 11 illustrates an example of MC-DCI including at least one of a cell set indicator field, a scheduling cell indicator field, and multiple FDRA fields according to an embodiment of the disclosure.

FIG. 12 is a diagram illustrating an example of a field indicating frequency domain resource allocation information according to subcarrier spacing of a cell, according to an embodiment of the disclosure.

FIG. 13 is a diagram illustrating an operation of a UE according to an embodiment of the disclosure.

FIG. 14 is a diagram illustrating an operation of a base station according to an embodiment of the disclosure.

FIG. 15 illustrates a structure of a UE in a wireless communication system according to an embodiment of the disclosure.

FIG. 16 illustrates a structure of a base station in a wireless communication system according to an embodiment of the disclosure.

### MODE FOR INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to abase station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) (which may be used interchangeably with cyclic prefix-orthogonal frequency division multiplexing (CP-OFDM)) scheme in a downlink and employs a single carrier frequency division multiple access (SC-FDMA) (which may be used interchangeably with discrete Fourier transform-spread-orthogonal frequency division multiplexing (DFTS-OFDM)) scheme in an uplink. The above multiple access scheme may separate data or control information of respective users by allocating and operating time-frequency resources for carrying the data or control information for each user so as to avoid overlapping therebetween, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000.000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

In the following description, the term “a/b” may be understood as at least one of a and b.

Hereinafter, a frame structure of a 5G system will be described in more detail with reference to the accompanying drawings.

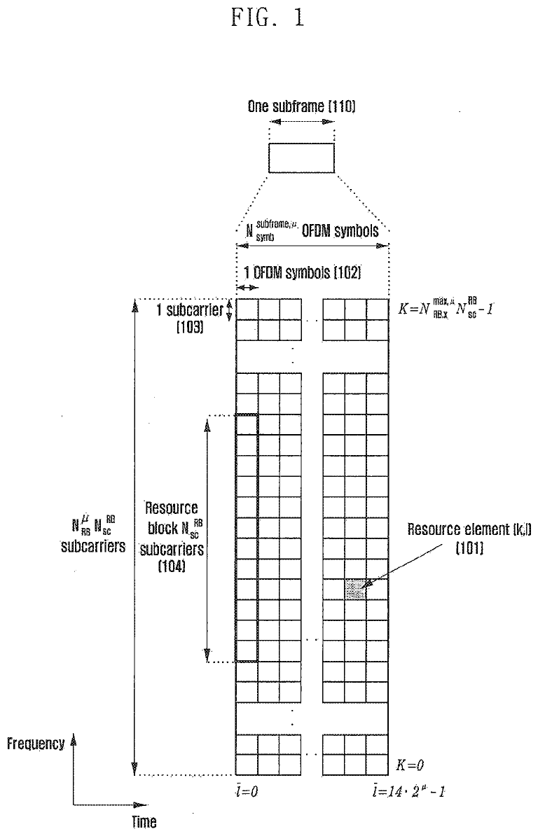

FIG. 1 illustrates a basic structure of a time-frequency domain, which is a radio resource domain used to transmit data or control channels, in a 5G system.

In FIG. 1, the horizontal axis denotes a time domain, and the vertical axis denotes a frequency domain. The basic unit of resources in the time and frequency domains is a resource element (RE) 101, which may be defined as one orthogonal frequency division multiplexing (OFDM) symbol 102 along the time axis and one subcarrier 103 along the frequency axis. In the frequency domain,

$${N}_{SC}^{RB}$$

(for example, 12) consecutive REs may constitute one resource block (RB) 104. In the time domain, one subframe 110 may include multiple OFDM symbols 102. For example, the length of one subframe may be 1 ms.

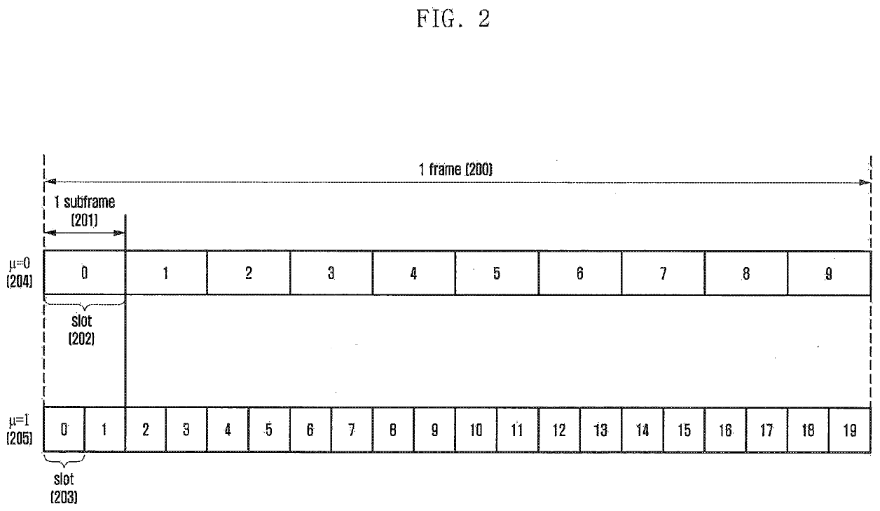

FIG. 2 illustrates an example of a structure of a frame, a subframe, and a slot in a 5G system.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include one or multiple slots 202 and 203, and the number of slots 202 and 203 per one subframe 201 may vary depending on configuration values μ for the subcarrier spacing 204 or 205. The example of FIG. 2 shows the case of μ=0 (2-04) and the case of μ=1 (2-05) as a configuration value for a subcarrier spacing. In the case of μ=0 (204), one subframe 201 may include one slot 202, and in the case of μ=1 (205), one subframe 201 may include two slots 203. That is, the number of slots per one subframe

$${N}_{slot}^{subframe , μ}$$

may differ depending on the subcarrier spacing configuration value p, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

Next, a bandwidth part (BWP) configuration in a 5G communication system will be described in detail with reference to the accompanying drawings.

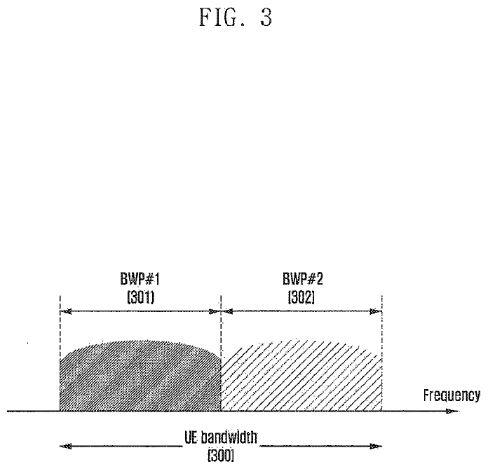

FIG. 3 illustrates an example of a bandwidth part configuration in a 5G communication system.

FIG. 3 illustrates an example in which a UE bandwidth 300 is configured to include two bandwidth parts, that is, bandwidth part #1 (BWP #1) 301 and bandwidth part #2 (BWP #2) 302. A base station may configure one or multiple bandwidth parts for a UE, and may configure the following pieces of information with regard to each bandwidth part as given in Table 2 below.

TABLE 2

| | |
|---|---|
| BWP ::= | SEQUENCE { |
| bwp-Id | BWP-Id, |

(bandwidth part identifier)

| | |
|---|---|
| location AndBandwidth | INTEGER (1..65536), |
| (bandwidth part location) | |
| subcarrier Spacing | ENUMERATED {n0, n1, n2, n3, n4, n5}, |
| (subcarrier spacing) | |
| cyclicPrefix | ENUMERATED { extended } |
| (cyclic prefix) | |
| } | |

Obviously, the above example is not limiting, and various parameters related to the bandwidth part may be configured for the UE, in addition to the above configuration information. The base station may transfer the configuration information to the UE through higher layer signaling, for example, radio resource control (RRC) signaling. One configured bandwidth part or at least one bandwidth part among multiple configured bandwidth parts may be activated. Whether or not the configured bandwidth part is activated may be transferred from the base station to the UE semi-statically through RRC signaling, or dynamically through downlink control information (DCI).

According to some embodiments, before a radio resource control (RRC) connection, an initial bandwidth part (BWP) for initial access may be configured for the UE by the base station through a master information block (MIB). More specifically, the UE may receive configuration information regarding a control resource set (CORESET) and a search space which may be used to transmit a PDCCH for receiving system information (which may correspond to remaining system information (RMSI) or system information block 1 (SIB1) necessary for initial access through the MIB in the initial access step. Each of the control resource set and the search space configured through the MIB may be considered identity (ID) 0. The base station may notify the UE of configuration information, such as frequency allocation information, time allocation information, and numerology, regarding control resource region #0 through the MIB. In addition, the base station may notify the UE of configuration information regarding the monitoring cycle and occasion with regard to control resource set #0, that is, configuration information regarding search space #0, through the MIB. The UE may consider that a frequency domain configured by control resource set #0 acquired from the MIB is an initial bandwidth part for initial access. The ID of the initial bandwidth part may be considered to be 0.

The UE may receive, through the configured initial bandwidth part, a physical downlink shared channel (PDSCH) through which an SIB is transmitted. The initial bandwidth part may be used not only for the purpose of receiving the SIB, but also for other system information (OSI), paging, random access, or the like.

In a wireless communication system, one or more different antenna ports (which may be replaced with one or more channels, signals, and combinations thereof, but in the following description of the disclosure, will be referred to as different antenna ports, as a whole, for the sake of convenience) may be associated with each other by a quasi-co-location (QCL) configuration as in Table 3 below. A transmission configuration indicator (TCI) state is for announcing the QCL relation between a PDCCH (or a PDCCH demodulation reference signal (DRMS)) and another reference signal (RS) or channel, and the description that a reference antenna port A (reference RS #A) and another target antenna port B (target RS #B) are QCLed with each other means that the UE is allowed to apply some or all of large-scale channel parameters estimated in the antenna port A to channel measurement form the antenna port B. The QCL needs to be associated with different parameters according to the situation such as 1) time tracking influenced by average delay and delay spread, 2) frequency tracking influenced by Doppler shift and Doppler spread. 3) radio resource management (RRM) influenced by average gain, or 4) beam management (BM) influenced by a spatial parameter. Accordingly, four types of QCL relations are supported in NR as in Table 3 below.

TABLE 3

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may refer to some or all of various parameters as a whole, such as angle of arrival (AoA), power angular spectrum (PAS) of AoA, angle of departure (AoD), PAS of AoD, transmit/receive channel correlation, transmit/receive beamforming, and spatial channel correlation.

The QCL relations may be configured for the UE through RRC parameter TCI-state and QCL-info as in Table 4 below. Referring to Table 4, the base station may configure one or more TCI states for the UE, thereby informing of a maximum of two kinds of QCL relations (qcl-Type1, qcl-Type2) regarding the RS that refers to the ID of the TCI state, that is, the target RS. Each piece of QCL information (QCL-Info) included in each TCI state includes the serving cell index and the BWP index of the reference RS indicated by the corresponding QCL information, the type and ID of the reference RS, and a QCL type as in Table 3 above.

TABLE 4

| | |
|---|---|
| TCI-State ::= | SEQUENCE { |
| tci-StateId | TCI-StateId, |
| (ID of corresponding TCI state) | |
| qcl-Type1 | QCL-Info, |

(QCL information of first refernece RS of RS (target RS) referring to corresponding

| | |
|---|---|
| TCI state ID) | |
| qcl-Type2 QCL-Info | OPTIONAL, -- Need R |

(QCL information of second refernece RS of RS (target RS) referring to corresponding

| | |
|---|---|
| TCI state ID) | |
| ... | |
| } | |
| QCL-Info ::= | SEQUENCE { |
| cell ServCellIndex | OPTIONAL, -- Need R |

(serving cell index of reference RS indicated by corresponding QCL information)

| | |
|---|---|
| bwp-Id BWP-Id | OPTIONAL, -- Cond CSI-RS-Indicated |

(BWP index of reference RS indicated by corresponding QCL information)

| | |
|---|---|
| referenceSignal | CHOICE { |
| csi-rs | NZP-CSI-RS-ResourceId, |
| ssb | SSB-Index |

(one of CSI-RS ID or SSB ID indicated by corresponding QCL information)

| | |
|---|---|
| }, | |
| qcl-Type | ENUMERATED {typeA, typeB, typeC, typeD}, |
| ... | |
| } | |

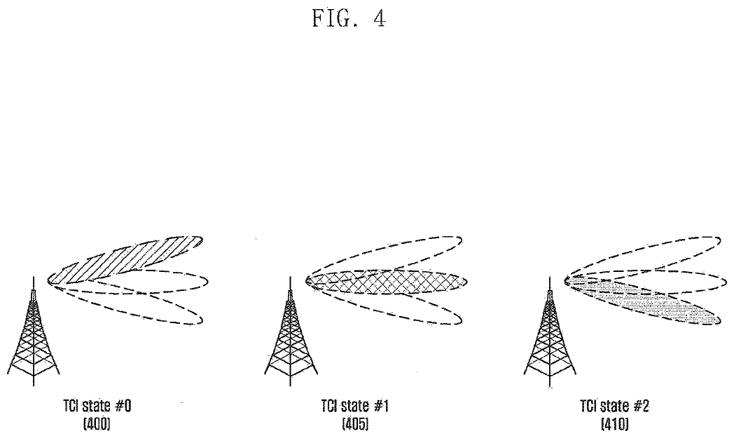

FIG. 4 illustrates an example of base station beam allocation according to a TCI state configuration.

Referring to FIG. 4, the base station may transfer information regarding N different beams to the UE through N different TCI states.

For example, in the case of N=3 as in FIG. 4, the base station may configure qcl-Type2 parameters included in three TC states 400, 405, and 410 in QCL type D while being associated with channel state information-reference signals (CSI-RSs) or synchronization signal blocks (SSBs, which may be used interchangeably with “SS/PBCHs”) corresponding to different beams, thereby notifying that antenna ports referring to the different TCI states 400, 405, and 410 are associated with different spatial Rx parameters, that is, different beams.

Next, downlink control information (DCI) in a 5G communication system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH). A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 5 below, for example.

TABLE 5
- Identifier for DCI formats - [1] bit
- $Frequency domain resource assignment - [ ⌈ {log}_{2} ( {N}_{RB}^{DL , BWP} ( {N}_{RB}^{DL , BWP} + 1 ) / 2 ⌉ ]$
bits
- Time domain resource assignment - X bits
- Frequency hopping flag - 1 bit.
- Modulation and coding scheme - 5 bits
- New data indicator - 1 bit
- Redundancy version - 2 bits
- HARQ process number - 4 bits
- Transmit power control (TPC) command for scheduled PUSCH - [2] bits
- Uplink/supplementary uplink (UL/SUL) indicator - 0 or 1 bit

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 6 below, for example.

```
TABLE 6
- Carrier indicator - 0 or 3 bits
- UL/SUL indicator -- 0 or 1 bit
- Identifier for DCI formats - [1] bits
- Bandwidth part indicator - 0, 1 or 2 bits
- Frequency domain resource assignment
            $◦ For resource allocation type 0 , ⌈ {N}_{RB}^{DL , BWP} / P ⌉ bits$
            $◦ For resource allocation type 1 , ⌈ {log}_{2} ( {N}_{RB}^{DL , BWP} ( {N}_{RB}^{DL , BWP} + 1 ) / 2 ) ⌉ bits$
- Time domain resource assignment - 1, 2, 3, or 4 bits
- Virtual resource block (VRB)-to-physical resource block (PRB) mapping - 0
or 1 bit, only for resource allocation type 1.
            ○ 0 bit if only resource allocation type 0 is configured;
            ○ 1 bit otherwise.
- Frequency hopping flag - 0 or 1 bit, only for resource allocation type 1.
            ○ bit if only resource allocation type 0 is configured;
            ○ 1 bit otherwise.
- Modulation and coding scheme - 5 bits
- New data indicator - 1 bit
- Redundancy version - 2 bits
- HARQ process number - 4 bits
- 1st downlink assignment index - 1 or 2 bits
            ○ 1 bit for semi-static HARQ-ACK codebook;
            ○ 2 bits for dynamic HARQ-ACK codebook with single HARQ-ACK
            codebook.
- 2nd downlink assignment index - 0 or 2 bits
            ○ 2 bits for dynamic HARQ-ACK codebook with two HARQ-ACK
            sub-codebooks;
            ○ 0 bit otherwise.
- TPC command for scheduled PUSCH - 2 bits
-  $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$
            $◦ ⌈ {log}_{2} ( {\sum }_{k = 1}^{{L}_{max}} ( \begin{matrix}{N}_{SRS} \\ k\end{matrix} ) ) ⌉ bits for non - codebook based PUSCH$
            transmission;
            ○ ┌log₂(N_{SRS})┐ bits for codebook based PUSCH transmission.
- Precoding information and number of layers - up to 6 bits
- Antenna ports - up to 5 bits
- SRS request - 2 bits
- Channel state information (CSI) request - 0, 1, 2, 3, 4, 5, or 6 bits
- Code block group (CBG) transmission information - 0, 2, 4, 6, or 8 bits
- Phase tracking reference signal (PTRS)-demodulation reference signal
(DMRS) association - 0 or 2 bits.
- beta_offset indicator - 0 or 2 bits
- DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 7 below, for example.

TABLE 7
- Identifier for DCI formats - [1] bit
- $Frequency domain resource assignment - [ ⌈ {log}_{2} ( {N}_{RB}^{DL , BWP} ( {N}_{RB}^{DL , BWP} + 1 ) / 2 ⌉ ]$
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Physical uplink control channel (PUCCH) resource indicator - 3 bits
- PDSCH-to-HARQ feedback timing indicator - [3] bits

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 8 below, for example.

```
TABLE 8
- Carrier indicator - 0 or 3 bits
- Identifier for DCI formats - [1] bits
- Bandwidth part indicator - 0, 1 or 2 bits
- Frequency domain resource assignment
            $◦ For resource allocation type 0 , ⌈ {N}_{RB}^{DL , BWP} / P ⌉ bits$
            $◦ For resource allocation type 1 , ⌈ {log}_{2} ( {N}_{RB}^{DL , BWP} ( {N}_{RB}^{DL , BWP} + 1 ) / 2 ) ⌉ bits$
- Time domain resource assignment - 1, 2, 3, or 4 bits
- VRB-to-PRB mapping - 0 or 1 bit, only for resource allocation type 1.
            ○ 0 bit if only resource allocation type 0 is configured;
            ○ 1 bit otherwise.
- Physical resource block (PRB) bundling size indicator - 0 or 1 bit
- Rate matching indicator - 0, 1, or 2 bits
- Zero power (ZP) channel state information (CSI)-reference signal (RS) trigger -
0, 1, or 2 bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- CBG flushing out information - 0 or 1 bit
- DMRS sequence initialization - 1 bit
```

Hereinafter, a downlink control channel in a 5G communication system will be described in more detail with reference to the accompanying drawings.

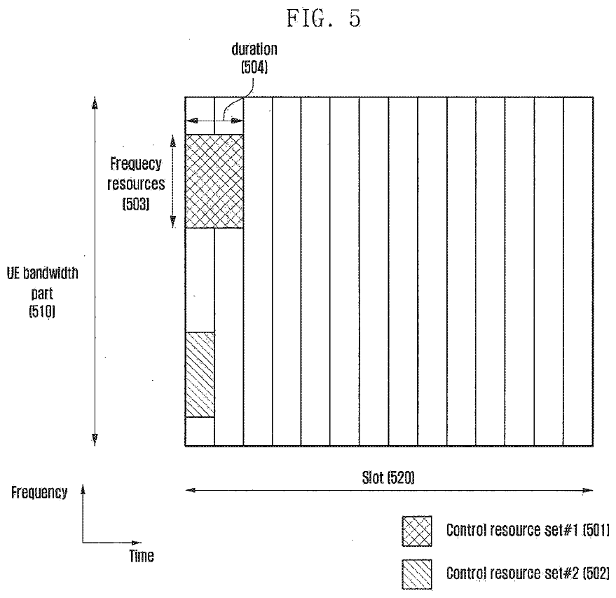

FIG. 5 illustrates an example of a control resource set (CORESET) used to transmit a downlink control channel in a 5G communication system. FIG. 5 illustrates an example in which a UE bandwidth part 510 is configured along the frequency domain, and two control resource sets (control resource set #1 520 and control resource set #2 501) are configured within one slot 502 along the time domain. The control resource sets 501 and 502 may be configured in a specific frequency resource 510 within the entire UE bandwidth part 503 along the frequency domain. The control resource sets 501 and 502 may be each configured as one or multiple OFDM symbols along the time domain, and the number of the OFDM symbols may be defined as a control resource set duration 504. Referring to the example illustrated in FIG. 5, control resource set #1 501 is configured to have a control resource set duration corresponding to two symbols, and control resource set #2 502 is configured to have a control resource set duration corresponding to one symbol.

A control resource set in 5G described above may be configured for a UE by a base station through higher layer signaling (for example, system information, MIB, RRC signaling, etc.). The description that a control resource set is configured for a UE means that information such as a control resource set identity, the control resource set's frequency location, and the control resource set's symbol duration is provided. For example, this information may include the following pieces of information given in Table 9 below.

TABLE 9

| | |
|---|---|
| ControlResourceSet ::= | SEQUENCE { |

-- Corresponds to L1 parameter ′CORESET-ID′

| | |
|---|---|
| controlResourceSetId | ControlResourceSetId, |
| (control resource set identity)) | |
| frequency DomainResources | BIT STRING (SIZE (45)), |

(frequency domain resource assignment information)

| | |
|---|---|
| duration | INTEGER (1..maxCoReSetDuration), |

(time domain resource assignment information )

| | |
|---|---|
| cce-REG-MappingType | CHOICE { |
| (CCE-to-REG mapping scheme) | |
| interleaved | SEQUENCE { |
| reg-BundleSize | ENUMERATED {n2, n3, n6}, |
| (REG bundle size) | |

precoderGranularity ENUMERATED {sameAsREG-bundle, allContiguousRBs},

| | |
|---|---|
| interleaverSize | ENUMERATED {n2, n3, n6} |
| (interleaver size) | |

shiftIndex INTEGER(0..maxNrofPhysicalResourceBlocks-1)

| | |
|---|---|
| OPTIONAL | |
| (interleaver shift) | |
| }, | |
| nonInterleaved | NULL |
| }, | |

```
  tci-StatesPDCCH SEQUENCE(SIZE(1..maxNrofTCI-StatesPDCCH)) OF TCI-
  StateId OPTIONAL,
    (QCL configuration information)
  tci-PresentInDCI ENUMERATED {enabled} OPTIONAL, -- Need S
}
```

In Table 9, tci-StatesPDCCH(simply referred to as TC state) configuration information may include information of one or multiple synchronization signal/physical broadcast channel (SS/PBCH) block indexes or channel state information-reference signal (CSI-RS) indexes, which are quasi-co-located (QCLed) with a DMRS transmitted in a corresponding control resource set.

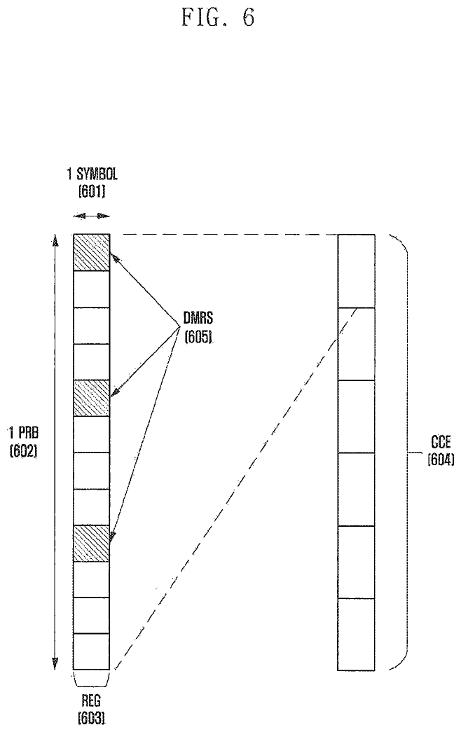

FIG. 6 illustrates an example of a basic unit of time and frequency resources constituting a downlink control channel available in a 5G system. According to FIG. 6, the basic unit of time and frequency resources constituting a control channel may be referred to as a resource element group (REG) 603, and the REG 603 may be 10 defined by one OFDM symbol 601 along the time domain and one physical resource block (PRB) 602, that is. 12 subcarriers, along the frequency domain. The base station may configure a downlink control channel allocation unit by concatenating the REGs 603.

Provided that the basic unit of downlink control channel allocation in a 5G system is a control channel element (CCE) 604 as illustrated in FIG. 6, one CCE 604 may include multiple REGs 603. To describe the REG 603 illustrated in FIG. 6, for example, the REG 603 may include 12 REs, and if one CCE 604 includes six REGs 603, one CCE 604 may then include 72 REs. A downlink control resource set, once configured, may include multiple CCEs 604, and a specific downlink control channel may be mapped to one or multiple CCEs 604 and then transmitted according to the aggregation level (AL) in the control resource set. The CCEs 604 in the control resource set are distinguished by numbers, and the numbers of CCEs 604 may be allocated according to a logical mapping scheme.

The basic unit of the downlink control channel illustrated in FIG. 6, that is, the REG 603, may include both REs to which DCI is mapped, and an area to which a reference signal (DMRS 605) for decoding the same is mapped. As in FIG. 6, three DRMSs 605 may be transmitted inside one REG 603. The number of CCEs necessary to transmit a PDCCH may be 1, 2, 4, 8, or 16 according to the aggregation level (AL), and different number of CCEs may be used to implement link adaption of the downlink control channel. For example, in the case of AL=L, one downlink control channel may be transmitted through L CCEs. The UE needs to detect a signal while being no information regarding the downlink control channel, and thus a search space indicating a set of CCEs has been defined for blind decoding. The search space is a set of downlink control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH in order to receive cell-common control information such as dynamic scheduling regarding system information or a paging message. For example, PDSCH scheduling allocation information for transmitting an SIB including a cell operator information or the like may be received by searching the common search space of the PDCCH. In the case of a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In a 5G system, parameters for a search space regarding a PDCCH may be configured for the UE by the base station through upper layer signaling (for example, SIB. MIB, or RRC signaling). For example, the base station may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a control resource set index for monitoring the search space, and the like. For example, this information may include the following pieces of information given in Table 10 below.

TABLE 10

| | |
|---|---|
| SearchSpace ::= | SEQUENCE { |

-- Identity of the search space. SearchSpaceId = 0 identifies the SearchSpace configured via PBCH

| | |
|---|---|
| (MIB) or ServingCellConfigCommon. | |
| search SpaceId | SearchSpaceId, |
| (search space identity) | |
| controlResourceSetId | ControlResourceSetId, |
| (control resource set identity) | |
| monitoringSlotPeriodicityAndOffset | CHOICE { |
| (monitoring slot level periodicity) | |
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |
| } | OPTIONAL, |
| duration(monitoring duration) | INTEGER (2..2559) |
| monitoringSymbols WithinSlot | BIT STRING (SIZE (14)) OPTIONAL, |
| (monitoring symbols within slot) | |
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |
| }, | |
| searchSpace Type | CHOICE { |
| (search space type) | |

-- Configures this search space as common search space (CSS) and DCI formats to monitor.

| | |
|---|---|
| common | SEQUENCE { |
| (common search space) | |
| } | |
| ue-Specific | SEQUENCE { |
| (UE-specific search space) | |

-- Indicates whether the UE monitors in this USS for DCI formats 0-0 and 1-0 or for formats

0-1 and 1-1.

formats ENUMERATED {formats0-0-And-1-0, formats0-1-And-1-1},

```
      ...
    }
```

According to configuration information, the base station may configure one or multiple search space sets for the UE. According to some embodiments, the base station may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. Obviously, the examples given below are not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. Obviously, the examples given below are not limiting.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI
Enumerated RNTIs may follow the definition and usage given below
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for physical uplink control channel (PUCCH) RNTI (TPC-PUCCH-RNTI): used to indicate a power control command regarding a PUCCH
Transmit power control for sounding reference signal (SRS) RNTI (TPC-SRS-RNTI): used to indicate a power control command regarding an SRS
The DCI formats enumerated above may follow the definitions given in Table 11 below.

TABLE 11

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS trans |
| | missions by one or more UEs |

In a 5G system, the search space at aggregation level L in connection with control resource set p and search space set s may be expressed by Equation 1 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad [ Equation 1 ]$$

L: aggregation level
n_{CI}: carrier index
N_{CCE,p}: total number of CCEs existing in control resource set p

$${n}_{s , f}^{μ}$$

slot index

$${M}_{s , max}^{( L )}$$

number of PDCCH candidates at aggregation level L

$${m}_{s , {n}_{CI}} = 0 , … , {M}_{s , max}^{( L )} - 1$$

PDCCH candidate index at aggregation level L

$$i = 0 , … , L - 1$$

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ=39827 for p mod 3=0, Aₚ=39829 for p mod 3=1, Aₚ=39839 for p mod 3=2, D=65537
n_{RNTI}: UE identity

The

$${Y}_{p , {n}_{s , f}^{μ}}$$

value may correspond to 0 in the case of a common search space.

$${Y}_{p , {n}_{s , f}^{μ}}$$

The Y value may correspond to a value changed by the UE's identity (C-RNTI or ID configured for the UE by the base station) and the time index in the case of a UE-specific search space.

In a 5G system, multiple search space sets may be configured by different parameters (for example, parameters in Table 10), and the group of search space sets monitored by the UE at each time point may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

Next, frequency domain resource assignment (FDRA) with regard to a PDSCH or PUSCVH in NR will be described.

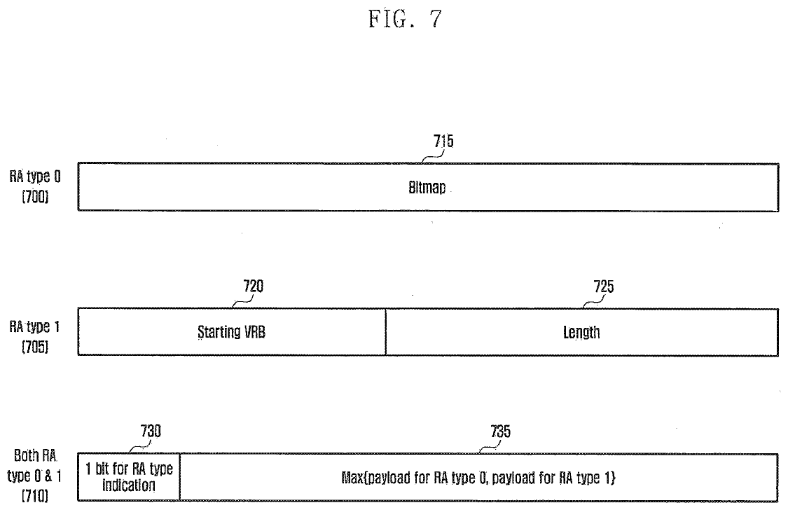

FIG. 7 illustrates an example of frequency domain resource assignment with regard to a PDSCH or PUSCH in a wireless communication system according to an embodiment of the disclosure.

FIG. 7 illustrates three frequency domain resource allocation methods including FDRA type 0 700, FDRA type 1 705, and dynamic switch 710 which may be configured through an higher layer in an NR wireless communication system.

Referring to FIG. 7, in case that a UE is configured to use only FDRA Type 0 through higher-layer signaling (700), partial downlink control information (DCI) for scheduling a PDSCH or a PUSCH for the UE includes a bitmap configured by N_{RBG} bits. The conditions for this will be described again later. As used herein. N_{RBG} refers to the number of resource block groups (RBGs) determined according to the size of the bandwidth part indicated by the bandwidth part indicator and higher layer parameter rbg-Size, as in Table 12 below, and data is transmitted in the RBG marked as 1 by the bitmap.

TABLE 12

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

The size of the frequency resource of a bandwidth part may be defined as the number of RBs that the bandwidth part includes. More specifically, in case that FDRA Type-0 resource allocation is indicated to a UE, the length of the FDRA field of the DCI received the UE is equal to the number of RBGs (N_{RBG}) within the bandwidth part, and

$${N}_{RBG} = ⌈ ( {N}_{B W P}^{s i z e} + ( {N}_{BWP}^{start} + {N}_{BWP}^{start} mod P ) ) / P ⌉ .$$

The first RBG in the bandwidth part includes as many RBs as

$$R B {G}_{0}^{s i z e} = P - {N}_{B W P}^{s i z e} mod P ,$$

and the last RBG in the bandwidth part includes as many RBs as

$$R B {G}_{last}^{s i z e} = ( {N}_{B W P}^{s t a r t} + {N}_{B W P}^{size} ) mod P if ( {N}_{BWP}^{start} + {N}_{BWP}^{s i z e} ) mod P > 0 ,$$

and as many RBs as

$$R B {G}_{last}^{s i z e} = P$$

otherwise. The other RBGs within the bandwidth part include P RBs. Here, P refers to the number of nominal RBGs as determined according to Table 12 above.

In case that the UE is configured to use only FDRA Type 1 through higher-layer signaling (705), the DCI for allocating a PDSCH or a PUSCH to the UE includes frequency domain resource allocation (FDRA) information configured by as many bits as

$$⌈ {log}_{2} ( {N}_{R B}^{B W P} * ( {N}_{R B}^{B W P} + 1 ) / 2 ⌉ .$$

### Here,

$${N}_{R B}^{BWP}$$

refers to the number of RBs included in the bandwidth part. The base station may thereby configure a starting virtual resource block (starting VRB) 720 and the length 725 of a frequency domain resource allocated continuously therefrom.

If the UE is not configured with the higher layer signaling vrb-ToPRB-Interleaver, the UE may associate the resources allocated to the VRBs to the PRBs without interleaving. →If the UE is configured with the higher layer signaling vrb-ToPRB-Interleaver, the higher layer signaling has a value of 2 or 4, which may be multiple units of RBs performing interleaving. That is, a bundle of RBs of 2 or 4 units may be used for interleaving.

If the i^{th} BWP starting from position

$${N}_{BWP , i}^{start}$$

and having a length corresponding to as many RBs as

$${N}_{BWP , i}^{s i z e}$$

is configured for the UE and the vrb-ToPRB-Interleaver is configure to be Lₜ, the UE may divide the i^{th} BWP into as many RB bundles as

$${N}_{bundle} = ⌈ ( {N}_{BWP , i}^{s i z e} + ( {N}_{B WP , i}^{start} mod {L}_{i} ) ) / {L}_{i} ⌉ ,$$

and each RB bundle may be configured by as many RBs as Lᵢ.
In the i^{th} BWP, the first RB bundle may be configured by as many RBs as

$${L}_{i} - ( {N}_{BWP , i}^{s i z e} mod {L}_{i} ) .$$

In the i^{th} BWP, the last RB bundle may be configured by as many RBs as

$$( {N}_{BWP , i}^{start} + {N}_{BWP , i}^{size} ) mod {L}_{i}$$

if the value of

$$( {N}_{BWP , i}^{start} + {N}_{BWP , i}^{size} ) mod {L}_{i}$$

is greater than 0, and may be configured by as many RBs as Lᵢ otherwise.
In the i^{th} BWP, the other RB bundles may be configured by as many RBs as Lᵢ.

Here, the VRBs may be connected to the PRBs according to the following method.
The last VRB bundle may be connected to the last PRB bundle.

The j^{th} (j=0, 1, . . . , N_{bundle}−2) VRB bundle may be connected to the f(j)^{th} PRB bundle, and f(j) may be expressed as given in Equation 2 below.

$$f ( j ) = r C + c \qquad [ Equation 2 ]$$

$$j = cR + r$$

$$r = 0 , 1 , … , R - 1$$

$$c = 0 , 1 , … , C - 1$$

$$R = 2 C = ⌊ {N}_{bundle} / R ⌋$$

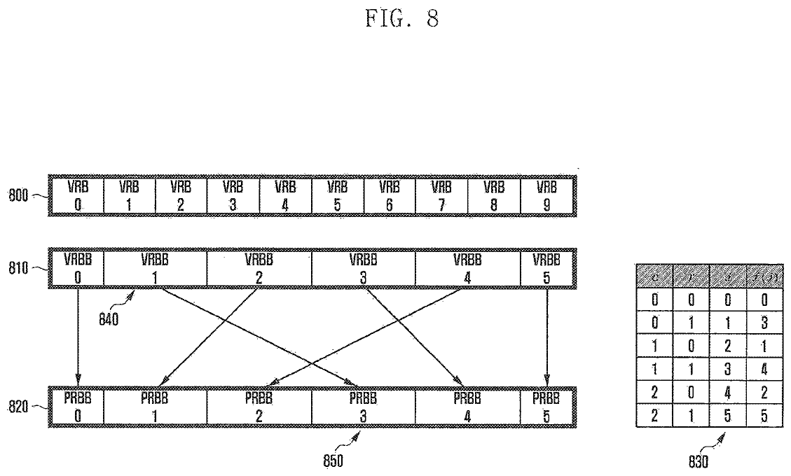

FIG. 8 illustrates an example of a VRB-PRB interleaving scheme of a PDSCH during FDRA type-1 resource allocation according to an embodiment of the disclosure. FIG. 7 illustrates a case 810 in which the first and last VRB bundles are configured by 1 VRB in a BWP including 10 RBs (indicated by reference numeral 800). Accordingly, the number of VRB bundles, N_{bundle}, may be 6, and C=└N_{bundle}/R┘=3 may be calculated by Equation 2 above. Therefore, since the jth VRB bundle may be connected to the fj)th PRB bundle according to Equation 2 above, the connection from the VRB bundle to the PRB bundle may be performed through the result 830 calculated by Equation 2 above as indicated by reference numeral “820”. For example, VRB bundle 1 840 may be connected to PRB bundle 3 850.

If the UE is configured to use both FDRA type-0 resource allocation and FDRA type-1 resource allocation through higher layer signaling as in “710” of FIG. 7, partial DCI for allocating a PDSCH/PUSCH to the corresponding UE includes frequency domain resource allocation information including as many bits as the larger value 735 among the payload 715 for configuring FDRA type-0 resource allocation and the payload 720 and 725 for configuring FDRA type-1 resource allocation. The conditions for this will be described again later. One bit may be added to the foremost part (MSB) of the frequency domain resource allocation information within the DCI, the bit having a value of “0” may indicate use of FDRA type-0 resource allocationtype-0, and the bit having a value of “1” may indicate use of FDRA type-1 resource allocation.

If an FDRA type-2 resource allocation method is configured for the UE through higher layer signaling, the FDRA type-2 resource allocation method may be indicated to the UE from the base station according to the following method.

In addition, the UE may receive indication of M interlace index sets as RB allocation information from the base station.

The interlace index m∈{0, 1, . . . , M−1} may be configured by common RBs {m, M+m, 2M+m, 3M+m, . . . }, and M may be defined as in Table 13.

TABLE 13

| μ | M |
|---|---|
| 0 | 10 |
| 1 | 5 |

The relationship of RB

$${n}_{IRB , m}^{μ} ∈ \{ 0 , 1 , … \}$$

in interlace m and bandwidth part i and the common RB

$${n}_{CRB}^{μ}$$

may be defined as follows.

$${n}_{CRB}^{μ} = M {n}_{IRB , m}^{μ} + {N}_{BWP , i}^{s t a r t , μ} + ( ( m - {N}_{BWP , i}^{start , μ} ) mod M )$$

where

$${N}_{BWP , i}^{s t a r t , μ}$$

is the common resource block where bandwidth part starts relative to common resource block 0. μ is subcarrier spacing index.

If the subcarrier spacing is 15 kHz (μ=0), the base station may notify the UE of the RB allocation information for the interlace set with (m0+1) indexes. In addition, the resource assignment field may be configured by a resource indication value (RIV). If the RIV is 0≤RIV<M(M+1)/2, l=0, 1, . . . L−1, the same may be configured by the starting interlace m₀ and the number L (L≥1) of continuous interlaces, and the value is as follows.

$$if ( L - 1 ) \leq ⌊ M / 2 ⌋ then$$

$$RIV = M ( L - 1 ) + {m}_{0}$$

$$else$$

$$RIV = M ( M - L + 1 ) + ( M - 1 - {m}_{0} )$$

If the RIV is RIV≥M(M+1)/2, the RIV is configured by the starting interlace index m0 and 1 values, and may be configured as in Table 14.

TABLE 14

| RIV − M(M + 1)/2 | m₀ | 1 |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

If the subcarrier spacing is 30 kHz (μ=1), the base station may notify the UE of the RB allocation information in the form of a bitmap indicating the interlaces allocated to the UE. The size of the bitmap is M, and each 1 bit of the bitmap corresponds to an interlace. The sequence of the interlace bitmap may be such that interlace indexes 0 to M−1 are mapped from an MSB to an LSB.

In addition, with regard to 15 kHz and 30 kHz, the least significant bit (LSB)

$$Y = ⌈ log 2 \frac{{N}_{RB - set}^{BWP} ( {N}_{RB - set}^{BWP} + 1 )}{2} ⌉$$

of the FDRA field may refer to consecutive RB sets scheduled by DCI format 0_1. The Y bit may be configured by a resource indication value (RIV_{RBset}). In

$$0 \leq {RIV}_{RBset} < {N}_{RB - set}^{BWP} ( {N}_{RB - set}^{BWP} + 1 ) / 2 ,$$

l=0, 1, . . . L_{RBset}−1, the RIV_{RBset} value may be determined by the starting RB set (RBset_{START}) and the number (L_{RBset} (L_{RBset}≥1)) of consecutive RB sets. The RIV_{RBset} value may be defined as follows.

```
  $if ( {L}_{RBset} - 1 ) \leq ⌊ {N}_{RB - set}^{BWP} / 2 ⌋$
  $then {RIV}_{RBset} = {N}_{RB - set}^{BWP} ( {L}_{RBset} - 1 ) + {RBset}_{START}$
    else
  ${RIV}_{RBset} = {N}_{RB - set}^{BWP} ( {N}_{RB - set}^{BWP} - {L}_{RBset} + 1 ) + ( {N}_{RB - set}^{BWP} - 1 -$
${RBset}_{START} )$
```

$${N}_{RB - set}^{BWP}$$

refers to the number of RB sets included in the bandwidth part, and may be determined by the number of guard gaps (or bands) within the carrier configured by higher-layer signaling (or preconfigured).

Hereinafter, a time domain resource allocation method regarding a data channel in a 5G system will be described.

A base station may configure a table for time domain resource allocation information regarding a physical downlink shared channel (PDSCH) and a physical uplink shared channel (PUSCH) for a UE through upper layer signaling (for example, RRC signaling). A table including a maximum of maxNrofDL-Allocations=16 entries may be configured for the PDSCH, and a table including a maximum of maxNrofUL-Allocations=16 entries may be configured for the PUSCH. In an embodiment, the time domain resource allocation information may include PDCCH-to-PDSCH slot timing (for example, corresponding to a slot-unit time interval between a time point at which a PDCCH is received and a time point at which a PDSCH scheduled by the received PDCCH is transmitted; labeled K0), PDCCH-to-PUSCH slot timing (for example, corresponding to a slot-unit time interval between a time point at which a PDCCH is received and a time point at which a PUSCH scheduled by the received PDCCH is transmitted; hereinafter, labeled K2), information regarding the location and length of the start symbol by which a PDSCH or PUSCH is scheduled inside a slot, the mapping type of a PDSCH or PUSCH, and the like. For example, information such as in Table 15 or Table 16 below may be transmitted from the base station to the UE.

TABLE 15
PDSCH-TimeDomainResourceAllocationList ::= SEQUENCE (SIZE(1..maxNrofDL-
Allocations)) OF PDSCH-TimeDomainResourceAllocation

| | |
|---|---|
| PDSCH-TimeDomainResourceAllocation ::= | SEQUENCE { |
| k0 INTEGER(0..32) | OPTIONAL, -- |
| Need S | |
| (PDCCH-to-PDSCH timing, slot unit) | |
| mapping Type | ENUMERATED {typeA, |
| typeB}, | |
| (PDSCH mapping type) | |
| startSymbolAndLength | INTEGER (0..127) |
| (start symbol and length of PDSCH) | |
| } | |

TABLE 16
PUSCH-TimeDomainResourceAllocationList ::= SEQUENCE (SIZE(1..maxNrofUL-
Allocations)) OF PUSCH-TimeDomainResourceAllocation

| | |
|---|---|
| PUSCH-TimeDomainResourceAllocation ::= | SEQUENCE { |

k2 INTEGER(0..32) OPTIONAL, -- Need

| | |
|---|---|
| S | |
| (PDCCH-to-PUSCH timing, slot unit) | |
| mappingType | ENUMERATED {typeA, typeB}, |
| (PUSCH mapping type) | |
| startSymbolAndLength | INTEGER (0..127) |
| (start symbol and length of PUSCH) | |
| } | |

The base station may notify the UF of one of the entries of the table regarding time domain resource allocation information described above through L1 signaling (for example, DCI) (for example, “time domain resource allocation (TDRA)” field in DCI may indicate the same). The UE may acquire time domain resource allocation information regarding a PDSCH or PUSCH, based on the DCI acquired from the base station.

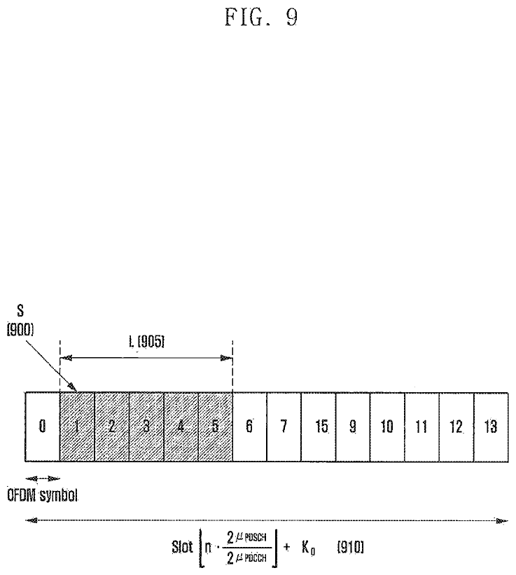

FIG. 9 illustrates an example of time domain resource allocation with regard to a PDSCH in a wireless communication system according to an embodiment of the disclosure.

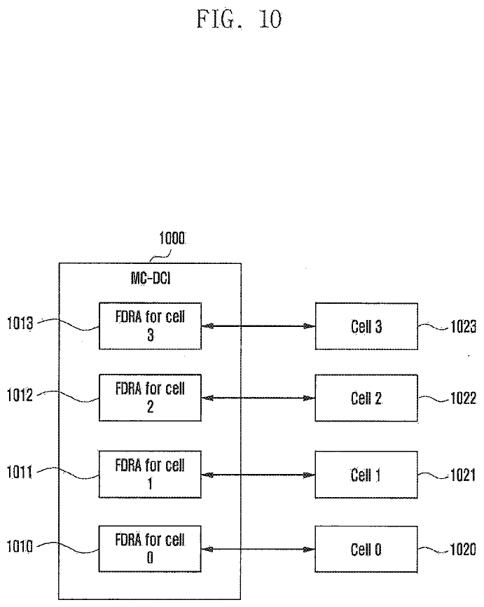

Referring to FIG. 10, the base station may indicate the time domain location of a PDSCH resource according to the subcarrier spacing (SCS) (μ_{PDSCH}, μ_{PDCCH}) of a data channel and a control channel configured by using a higher layer, the scheduling offset (K0) value, and the OFDM symbol start location 900 and length 905 within one slot dynamically indicated through DCI.

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1 PUSCH transmission may be configured semi-statically by receiving configuredGrantConfig including rrc-ConfiguredUplinkGrant in Table 17 through higher signaling, without receiving a UL grant inside DCI. Configured grant Type 2 PUSCH transmission may be scheduled semi-persistently by a UL grant inside DCI after receiving configuredGrantConfig not including rrc-ConfiguredUplinkGrant in Table 17 through upper signaling. If PUSCH transmission is operated by a configured grant, parameters applied to the PUSCH transmission are applied through configuredGrantConfig (upper signaling) in Table 17 except for dataScramblingldentityPUSCH, txConfig, codebookSubset, maxRank, and scaling of UCI-OnPUSCH, which are provided by pusch-Config (upper signaling) in Table 18. If provided with transformPrecoder inside configuredGrantConfig (upper signaling) in Table 17, the UE applies tp-pi2BPSK inside pusch-Config in Table 18 to PUSCH transmission operated by a configured grant.

```
TABLE 17
ConfiguredGrantConfig ::= SEQUENCE {
  frequencyHopping ENUMERATED {intraSlot, interSlot} OPTIONAL, -- Need S,
  cg-DMRS-Configuration DMRS-UplinkConfig,
  mcs-Table ENUMERATED {qam256, qam64LowSE} OPTIONAL, -- Need S
  mcs-TableTransformPrecoder ENUMERATED {qam256, qam64LowSE}
OPTIONAL, -- Need S
  uci-OnPUSCH SetupRelease { CG-UCI-OnPUSCH } OPTIONAL, -- Need M
  resourceAllocation ENUMERATED { resource Allocation Type0,
resourceAllocationType1, dynamicSwitch },
  rbg-Size ENUMERATED {config2} OPTIONAL, -- Need S
  powerControlLoopToUse ENUMERATED {n0, n1},
  p0-PUSCH-Alpha P0-PUSCH-AlphaSetId,
  transformPrecoder ENUMERATED {enabled, disabled} OPTIONAL, -- Need S
  nrofHARQ-Processes INTEGER(1..16),
  repK ENUMERATED {n1, n2, n4, n8},
  repK-RV ENUMERATED{s1-0231, s2-0303, s3-0000} OPTIONAL, -- Need R
  periodicity ENUMERATED {
  sym2, sym7, sym1x14, sym2x14, sym4x14, sym5x14, sym8x14, sym10x14, sym16x14,
sym20x14,
  sym32x14, sym40x14, sym64x14, sym80x14, sym128x14, sym160x14, sym256x14,
sym320x14, sym512x14,
  sym640x14, sym1024x14, sym1280x14, sym2560x14, sym5120x14,
  sym6, sym1x12, sym2x12, sym4x12, sym5x12, sym8x12, sym10x12, sym16x12, sym20x12,
sym32x12,
  sym40x12, sym64x12, sym80x12, sym128x12, sym160x12, sym256x12, sym320x12,
sym512x12, sym640x12,
  sym1280x12, sym2560x12
  },
  configuredGrantTimer INTEGER (1..64) OPTIONAL, -- Need R
  rrc-ConfiguredUplinkGrant SEQUENCE {
    timeDomainOffset   INTEGER (0..5119),
    timeDomainAllocation INTEGER (0..15),
    frequencyDomain Allocation BIT STRING (SIZE(18)),
    antennaPort INTEGER (0..31),
    dmrs-SeqInitialization INTEGER (0..1) OPTIONAL, -- Need R
    precodingAndNumberOfLayers INTEGER (0..63),
    srs-ResourceIndicator INTEGER (0..15) OPTIONAL, -- Need R
    mcsAndTBS INTEGER (0..31),
    frequencyHoppingOffset INTEGER (1..maxNrofPhysicalResourceBlocks-1)
OPTIONAL, -- Need R
    pathlossReferenceIndex INTEGER (0..maxNrofPUSCH-PathlossReferenceRSs-1),
  ...
  } OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 18, which is upper signaling, is“codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 18, the UE does not expect scheduling through DCI format 0_1.

```
TABLE 18
PUSCH-Config ::= SEQUENCE {
  dataScramblingIdentityPUSCH INTEGER (0..1023) OPTIONAL, -- Need S
  txConfig ENUMERATED {codebook, nonCodebook} OPTIONAL, -- Need S
  dmrs-UplinkForPUSCH-MappingTypeA SetupRelease { DMRS-UplinkConfig }
OPTIONAL, -- Need M
  dmrs-UplinkForPUSCH-MappingTypeB SetupRelease { DMRS-UplinkConfig }
OPTIONAL, -- Need M
  pusch-PowerControl PUSCH-PowerControl OPTIONAL, -- Need M
  frequencyHopping ENUMERATED {intraSlot, interSlot} OPTIONAL, -- Need S
  frequencyHoppingOffsetLists SEQUENCE (SIZE (1..4)) OF INTEGER (1..
maxNrofPhysicalResourceBlocks-1)
OPTIONAL, -- Need M
  resourceAllocation ENUMERATED { resourceAllocationType0,
resourceAllocationType1, dynamicSwitch},
  pusch-TimeDomainAllocationList SetupRelease { PUSCH-
TimeDomainResourceAllocationList } OPTIONAL, -- Need M
  pusch-AggregationFactor ENUMERATED { n2, n4, n8 }
OPTIONAL, -- Need S
  mcs-Table ENUMERATED {qam256, qam64LowSE}
OPTIONAL, -- Need S
  mcs-TableTransformPrecoder ENUMERATED {qam256, qam64LowSE}
OPTIONAL, -- Need S
  transformPrecoder     ENUMERATED {enabled, disabled}
OPTIONAL, -- Need S
  codebookSubset ENUMERATED
{fullyAndPartialAndNonCoherent, partialAndNonCoherent,nonCoherent}
  OPTIONAL, -- Cond codebookBased
  maxRank INTEGER(1..4)
OPTIONAL, -- Cond codebookBased
  rbg-Size     ENUMERATED{ config2}
OPTIONAL, -- Need S
  uci-OnPUSCH SetupRelease { UCI-OnPUSCH}
OPTIONAL, -- Need M
  tp-pi2BPSK ENUMERATED {enabled}
OPTIONAL, -- Need S
  ...
}
```

Next, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission lavers).

The SRI may be given through the SRI field in DCI or configured through srs-ResourceIndicator (higher signaling). During codebook-based PUSCH transmission, the UE has at least one SRS resource configured therefor, and may have a maximum of two SRS resources configured therefor. If the UE is provided with an SRI through DCI, the SRS resource indicated by the SRI refers to the SRS resource corresponding to the SRI among SRS resources transmitted prior to the PDCCH including the SRI. In addition, the TPMI and the transmission rank may be given through “precoding information and number of layers” (a field inside DCI) or configured through precodingAndNumberOfLayers (upper signaling). The TPMI is used to indicate a precoder to be applied to PUSCH transmission. If a single SRS resource is configured for the UE, the TPMI is used to indicate a precoder to be applied in the single SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “nonCoherent”,based on UE capability reported by the UE to the base station. If the UE reported “partialAndNonCoherent” as UE capability, the UE does not expect that the value of codebookSubset (upper signaling) will be configured as “fullyAndPartialAndNonCoherent”. If the UE reported “partialAndNonCoherent” as UE capability, the UE does not expect that the value of codebookSubset (upper signaling) will be configured as “fullyAndPartialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (upper signaling) is “codebook”, the UE expects that the value of nrofSRS-Ports inside SRS-Resource (upper signaling) is identical for all SRS resources.

The UE transmits, to the base station, one or multiple SRS resources included in the SRS resource set wherein the value of usage is configured as “codebook” according to upper signaling, and the base station selects one from the SRS resources transmitted by the UE and instructs the UE to transmit a PUSCH by using transmission beam information of the corresponding SRS resource. In connection with the codebook-based PUSCH transmission, the SRI is used as information for selecting the index of one SRS resource, and is included in DCI. Additionally, the base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

If the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS may be indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is located in the slot used to transmit the PDCCH including the SRS request field. In this case, TCI states configured for the scheduled subcarrier are not configured as QCL-TypeD.

If a periodic or semi-persistent SRS resource set is configured, the associated NZP CSI-RS may be indicated through associatedCSI-RS inside SRS-ResourceSet (higher signaling). With regard to non-codebook-based transmission, the UE does not expect that spatialRelationInfo, which is upper signaling regarding the SRS resource, and associatedCSI-RS inside SRS-ResourceSet, which is upper signaling, will be configured together.

If multiple SRS resources are configured for the UE, the UE may determine a precoder to be applied to PUSCH transmission and the transmission rank, based on an SRI indicated by the base station. The SRI may be indicated through the SRI field in DCI or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI. The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE configures one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE transmits the PUSCH by applying the precoder applied to SRS resource transmission to each layer.

Hereinafter, frequency hopping of a physical uplink shared channel (PUSCH) in a 5G system will be described in detail.

5G supports two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 3 below.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 3 ]$$

In Equation 3, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an higher layer parameter. The number of symbols of the first hop may be represented by

$$⌊ {N}_{symb}^{PUSCH , s} / 2 ⌋ ,$$

and number of symbols of the second hop may be represented by

$${N}_{symb}^{PUSCH , s} - ⌊ {N}_{symb}^{PUSCH , s} / 2 ⌋ . {N}_{symb}^{PUSCH , s}$$

is the length of PUSCH transmission in one slot and is expressed by the number of OFDM symbols.

The intra-slot frequency hopping method supported in PUSCH repetition type A transmission may include a method in which a UE transmits allocated resources in the frequency domain, after changing the same by a configured frequency offset, by two hops in one slot. The start RB during a slot in connection with inter-slot frequency hopping may be expressed by Equation 4 below.

$$R {B}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 4 ]$$

In Equation 4,

$${n}_{s}^{μ}$$

denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an higher layer parameter.

The inter-repetition frequency hopping method supported in PUSCH repeated transmission type B is a method in which resources allocated in the frequency domain regarding one or multiple actual repetitions in each nominal repetition are moved by a configured frequency offset and then transmitted. The index RBₛₜₐᵣₜ₍ₙ₎ of the start RB in the frequency domain regarding one or multiple actual repetitions in the nth nominal repetition may follow Equation 5 given below.

$${RB}_{start} ( n ) = \{ \begin{matrix}{RB}_{start} & n = 0 \\ ( {RB}_{start} + {RB}_{offset} ) mod {N}_{BWP}^{size} & n = 1\end{matrix} \qquad [ Equation 5 ]$$

In Equation 5, n denotes the index of nominal repetition, and RB_{offset} denotes an RB offset between two hops through an higher layer parameter.

Next, a TPMI indicated via DCI from a base station during codebook-based PUSCH transmission will be described.

If a UE is configured by a base station via DCI or higher-layer signaling, and is thus scheduled for I-layer transmission using a single PUSCH antenna port, W=1 may be defined for a TPMI. Otherwise, if the UE is configured by the base station via DCI or higher-layer signaling, and the UE is thus scheduled for PUSCH of 1 layer or more using multiple PUSCH antenna ports, W that is TPMI may be defined via Table 19 to Table 25 below.

TABLE 19

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

Table 19 shows 1-layer TPMIs when the UE has two PUSCH antenna ports. In Table 19, if the UE has a non-coherent antenna structure and has reported a corresponding UE capability to the base station, the base station may select one of TPMI indexes 0 and 1 and indicate same to the UE, and if the UE has a full-coherent antenna structure and has reported a corresponding UE capability to the base station, the base station may select one of TPMI indexes 0 to 5 and indicate same to the UE.

TABLE 20

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ - 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ - 1\end{matrix} ]$ | $\frac{1}{2} [ \begin{matrix}1 \\ - 1 \\ 1 \\ 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ - 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ - 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ 1\end{matrix} ]$ | — | — | — | — |

Table 20 shows TPMIs in which the UE has 4 PUSCH antenna ports and transform precoding is used (i.e., when a DFTS-OFDM waveform is used), and which are for one layer. In Table 20, if the UE has a non-coherent antenna structure and has reported a corresponding UE capability to the base station, the base station may select one of TPMI indexes 0 to 3 and indicate same to the UE. If the UE has a partial-coherent antenna structure and has reported a corresponding UE capability to the base station, the base station may select one of TPMI indexes 0 to 11 and indicate same to the UE. If the UE has a full-coherent antenna structure and has reported a corresponding UE capability to the base station, the base station may select one of TPMI indexes 0 to 27 and indicate same to the UE.

TABLE 21

| | W | | | | | | | |
|---|---|---|---|---|---|---|---|---|
| TPMI index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

Table 21 shows TPMIs in which the UE has 4 PUSCH antenna ports and transform precoding is not used (i.e., when a CP-OFDM waveform is used), and which are for one layer. In Table 21, if the UE has a non-coherent antenna structure and has reported a corresponding UE capability to the base station, the base station may select one of TPMI indexes 0 to 3 and indicate same to the UE. If the UE has a partial-coherent antenna structure and has reported a corresponding UE capability to the base station, the base station may select one of TPMI indexes 0 to 11 and indicate same to the UE. If the UE has a full-coherent antenna structure and has reported a corresponding UE capability to the base station, the base station may select one of TPMI indexes 0 to 27 and indicate same to the UE.

TABLE 22

| TPMI | W | | | |
|---|---|---|---|---|
| index | (ordered from left to right in increasing order of TPMI index) | | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ | — |

Table 22 shows TPMIs in which the UE has two PUSCH antenna ports and transform precoding is not used (i.e., when a CP-OFDM waveform is used), and which are for 1o layer. In Table 22, if the UE has anon-coherent antenna structure and has reported a corresponding UE capability to the base station, the base station may select TPMI index 0 and indicate same to the UE, and if the UE has a full-coherent antenna structure and has reported a corresponding UE capability to the base station, the base station may select one of TPMI indexes 0 to 2 and indicate same to the UE.

TABLE 23

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2} [ \begin{matrix}1 & 1 \\ - j & - j \\ j & - j \\ 1 & - 1\end{matrix} ]$ | — | — |

Table 23 shows TPMIs in which the UE has 4 PUSCH antenna ports and transform precoding is not used (i.e., when a CP-OFDM waveform is used), and which are for two layers. In Table 23, if the UE has a non-coherent antenna structure and has reported a corresponding UE capability to the base station, the base station may select one of TPMI indexes 0 to 5 and indicate same to the UE. If the UE has a partial-coherent antenna structure and has reported a corresponding UE capability to the base station, the base station may select one of TPMI indexes 0 to 13 and indicate same to the UE. If the UE has a full-coherent antenna structure and has reported a corresponding UE capability to the base station, the base station may select one of TPMI indexes 0 to 21 and indicate same to the UE.

TABLE 24

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

Table 24 shows TPMIs in which the UE has 4 PUSCH antenna ports and transform precoding is not used (i.e., when a CP-OFDM waveform is used), and which are for three layers. In Table 24, if the UE has a non-coherent antenna structure and has reported a corresponding UE capability to the base station, the base station may select TPMI index 0 and indicate same to the UE. If the UE has a partial-coherent antenna structure and has reported a corresponding UE capability to the base station, the base station may select one of TPMI indexes 0 to 2 and indicate same to the UE. If the UE has a full-coherent antenna structure and has reported a corresponding UE capability to the base station, the base station may select one of TPMI indexes 0 to 6 and indicate same to the UE.

TABLE 25

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

Table 25 shows TPMIs in which the UE has 4 PUSCH antenna ports and transform precoding is not used (i.e., when a CP-OFDM waveform is used), and which are for 4 layers. In Table 25, if the UE has a non-coherent antenna structure and has reported a corresponding UE capability to the base station, the base station may select TPMI index 0 and indicate same to the UE. If the UE has a partial-coherent antenna structure and has reported a corresponding UE capability to the base station, the base station may select one of TPMI indexes 0 to 2 and indicate same to the UE. If the UE has a full-coherent antenna structure and has reported a corresponding UE capability to the base station, the base station may select one of TPMI indexes 0 to 4 and indicate same to the UE.

In LTE and NR, a UE may perform a procedure in which, while being connected to a serving base station, the UE may report capability supported by the UE to the corresponding base station. In the following description, the above-described procedure will be referred to as a UE capability report.

The base station may transfer a UE capability enquiry message to a UE in a connected state so as to request a capability report. The message may include a UE capability request with regard to each radio access technology (RAT) type of the base station. The RAT type-specific request may include supported frequency band combination information and the like. In addition, in the case of the UE capability enquiry message, UE capability with regard to multiple RAT types may be requested through one RRC message container transmitted by the base station, or the base station may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR. LTE, E-UTRA—NR dual connectivity (EN-DC). The UE capability enquiry message may be transmitted initially after the UE is connected to the base station, in general, but may be requested in any condition if needed by the base station.

Upon receiving the UE capability report request from the base station in the above step, the UE may configure UE capability according to band information and RAT type requested by the base station. The method in which the UE configures UE capability in an NR system is summarized below.
1. If the UE receives a list regarding LTE and/or NR bands from the base station at a UE capability request, the UE constructs band combinations (BCs) regarding EN-DC and NR standalone (SA). That is, the UE configures a candidate list of BCs regarding EN-DC and NR SA, based on bands received from the base station at a request through FreqBandList. In addition, bands may have priority in the order described in FreqBandList.
2. If the base station has set “eutra-nr-only” flag or “eutra” flag and requested a UE capability report, the UE may remove everything related to NR SA BCs from the configured BC candidate list. Such an operation may occur only if an LTE base station (eNB) requests “eutra” capability.
3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.
4. The UE may select BCs appropriate for the requested RAT type from the final “candidate BC list” and select BCs to report. In this step, the UE configures supportedBandCombinationList in a determined order. That is, the UE configures BCs and UE capability to report according to a preconfigured rat-Type order. (nr->eutra-nr->eutra). In addition, the UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.
5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the base station. The base station performs scheduling and transmission/reception management appropriate for the UE, based on the UE capability received from the UE.

Hereinafter, embodiments of the disclosure will be described in detail in conjunction with the accompanying drawings. Hereinafter, the above examples may be described through several embodiments, but they are not independent of each other, and one or more embodiments may be applied simultaneously or in combination. In the following description of embodiments of the disclosure, 5G systems are described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure.

Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, determining priority between A and B may be variously described as, for example, selecting an entity having a higher priority according to a predetermined priority rule and performing an operation corresponding thereto, or omitting or dropping operations regarding an entity having a lower priority. As used herein, the term “slot” may generally refer to a specific time unit corresponding to a transmit time interval (TTI), may specifically refer to a slot used in a 5G NR system, or may refer to a slot or a subframe used in a 4G LTE system.

In the following description of the disclosure, higher layer signaling may refer to signaling corresponding to at least one signaling among the following signaling, or a combination of one or more thereof.
MIB
   SIB or SIB X (X=1, 2, . . . )
RRC
Medium access control (MAC) control element (CE)

In addition, L1 signaling may refer to signaling corresponding to at least one signaling method among signaling methods using the following physical layer channels or signaling, or a combination of one or more thereof.
PDCCH
DCI
UE-specific DCI
Group common DCI
Common DCI
Scheduling DCI (for example, DCI used for the purpose of scheduling downlink or uplink data)
Non-scheduling DCI (for example, DCI not used for the purpose of scheduling downlink or uplink data)
PUCCH
Uplink control information (UCI)

### Embodiment 1: MC-DCI Scheduling Method

As an embodiment of the disclosure, a scheduling method via multi-cell scheduling DCI (MC-DCI) is described. The embodiment may be implemented in combination with other embodiments.

In the disclosure, one DCI may be single-DCI or a single DCI format, and multiple DCIs may be multi-DCI or multiple DCI formats. In the disclosure, one DCI may be one PDCCH and/or may be transmitted and received via one PDCCH, and multiple DCIs may be multiple PDCCHs and/or may be transmitted and received via multiple PDCCHs. In the following, a specific cell being scheduled by DCI may be understood to indicate that a data channel on the specific cell is scheduled by the DCI. In addition, scheduling for a specific cell may be understood as scheduling a data channel on the specific cell.

In general, a UE may receive one DCI, and the one DCI may include scheduling information for one cell. For example, for DCI format 0_0/0_1/0_2, one PUSCH may be scheduled for one uplink cell. In addition, for DCI format 1_0/0_1/1_2, one PUSCH may be scheduled for one downlink cell. Here, the cell being scheduled may be indicated by a carrier indication field (CIF) of the DCI format.

However, according to this scheme, when a PDSCH or a PUSCH is scheduled in each of multiple cells, multiple DCIs need to be transmitted and received. Accordingly, a large DCI overhead may occur. In order to reduce DCI overhead, one DCI may be used to schedule a PDSCH or a PUSCH in each of multiple cells. For convenience, this may be referred to as multi-cell DCI (MC-DCI). In the disclosure, MC-DCI may be one DCI for scheduling a PDSCH and/or a PUSCH in each of multiple cells. In this case, a DCI format of the MC-DCI may be DCI format 1_X or 1_3 for PDSCH scheduling, and may be DCI format 0_X or 0_3 for PUSCH scheduling.

In a specific cell, the UE may report, as a UE capability to the base station, the number of candidate cell sets which may be scheduled via the MC-DCI. In this case, a cell set refers to a set including multiple cells, and for example, cell set 1 may include cell 1, cell 2, cell 3, and cell 4, and cell set 2 may include cell 5, cell 6, cell 7, and cell 8. The number of cells that may be included in a cell set may be up to 4, and cells included in each cell set may not overlap with one another. In this case, the number of candidate cell sets that the UE may report as a UE capability may be one or more.

If the UE has reported that the number of candidate cell sets which may be scheduled via MC-DCI within a specific cell is one, the UE may expect that there is no cell set indicator field in the MC-DCI, and if the UE has received MC-DCI from the base station, the UE may expect scheduling of cells within one cell set.

If the UE has reported that the number of candidate cell sets which may be scheduled via MC-DCI within a specific cell is two or more, the UE may expect that a cell set indicator field exists in the MC-DCI, and the UE may be indicated with one cell set index from the base station via the corresponding field. The UE may receive scheduling information for one or more cells within one of multiple cell sets via the MC-DCI. In the following, a case in which the number of candidate cell sets, which has been reported by the UE, is one is assumed and described, and a case in which the number of candidate cell sets is two or more is not excluded.

Cells which may be scheduled in MC-DCI may be configured via a higher layer. For example, it is assumed that the MC-DCI may be used for (simultaneously) scheduling cell 0, cell 1, cell 2, and cell 3. When the UE receives the MC-DCI, the UE may receive scheduling information for cell 0, cell 1, cell 2, and cell 3. That is, the UE may acquire the scheduling information for cell 0, cell 1, cell 2, and cell 3 from the MC-DCI. For example, it may be configured via a higher layer that the MC-DCI may be used for scheduling cell 0, cell 1, cell 2, and cell 3. Here, the scheduling information may include time domain resource allocation (TDRA) information and/or frequency domain resource allocation (FDRA) information for transmission and reception of a data channel (PDSCH for downlink or PUSCH for uplink) in each cell. Accordingly, the UE may acquire scheduling information for each cell via the MC-DCI and may transmit and receive a data channel on each cell.

There may be a case in which the base station cannot perform scheduling for all cells configured for the UE in a specific situation. A case in which scheduling is impossible for at least some of multiple cells configured for the UE by the base station may occur. For example, although the base station has configured, for the UE, 4 cells (e.g., cell 0, cell 1, cell 2, and cell 3) to be scheduled via the MC-DCI, the base station may not be able to schedule a data channel for some of the cells because of, for example, the cells being scheduled for another UE, a poor channel condition, or other various reasons. In this case, the base station should be able to indicate, to the UE, actually scheduled cells among the preconfigured cells which may be scheduled via the MC-DCI. That is, the base station should be able to indicate one or more (actually) scheduled cells among the multiple cells configured to be scheduled via the MC-DCI.

This may be indicated based on one of the following two methods, or may be indicated based on at least one of the following two methods or any combination thereof.

As a first method, the UE may acquire, from the MC-DCI, information indicating cells co-scheduled via the MC-DCI among the preconfigured cells (e.g., cell 0, cell 1, cell 2, and cell 3). That is, among the multiple cells configured to be scheduled via the MC-DCI, one or more cells actually co-scheduled via the MC-DCI may be identified based on the MC-DCI. More specifically, the base station may configure, for the UE, a table including the co-scheduled cells. For example, each row of the table may have a unique index. The index of each row (and/or each row) may include indexes of the co-scheduled cells. For example, {cell 0, cell 1} may be configured in row 0, {cell 2, cell 3} may be configured in row 1, and {cell 0, cell 1, cell 2, cell 3} may be configured in row 2. As an example of the table configured for the UE, Table 26 may be referenced.

TABLE 26

| index | Co-scheduled cell |
|---|---|
| 0 | {0, 1} |
| 1 | {2, 3} |
| 2 | {0, 1, 2, 3} |

The UE may acquire, from the MC-DCI, a value indicating an index of a row. Accordingly, based on the value, the UE may determine an actually scheduled cell. For example, the MC-DCI may include information on the index of the row, and the UE may identify the scheduled cell, based on the table and the index of the row acquired from the MC-DCI. For example, when row 0 is indicated from the MC-DCI, the UE may identify that cell 0 and cell 1 are scheduled cells. For example, when row 1 is indicated from the MC-DCI, the UE may identify that cell 2 and cell 3 are scheduled cells. For example, when row 2 is indicated from the MC-DCI, the UE may identify that cell 0, cell 1, cell 2, and cell 3 are scheduled cells.

In the disclosure, a table for a mapping relationship between a scheduled cell (or an index of a scheduled cell) and an index indicated from DCI is configured, and the scheduled cell may be identified based on the table and the index indicated from the DCI.

The disclosure describes an embodiment in which a co-scheduled cell is identified based on a row index of the table, but is not limited thereto. For example, the scheduled cell may also be identified based on a column index of the table, in which case, the row in the aforementioned embodiment may be replaced with the column.

In the disclosure, if the number of candidate cell sets that the UE may be scheduled via MC-DCI received within a specific cell is two or more, the UE may be configured with a table as above for each cell set, and may determine, via a cell set indicator field in the MC-DCI, a table of which cell set is to be used.

As a second method, the UE may determine, based on an FDRA field of the MC-DCI, whether scheduling information exists for one or more cells.

If the UE has reported that the number of candidate cell sets which may be scheduled via MC-DCI within a specific cell is one, the UE may expect that as many FDRA fields as the number of cells included in one cell set exist in the MC-DCI. In this case, if the UE has failed to receive a higher-layer signaling configuration such as the table mentioned in the first method, the UE may determine, based on one or more FDRA fields in the MC-DCI, whether scheduling information for each cell exists.

If the UE has reported, via UE capability reporting, that the number of candidate cell sets which may be scheduled via MC-DCI within a specific cell is two or more, the UE may expect that there exist as many FDRA fields as the maximum number of cells included in each of the two or more cell sets. For example, if the UE has reported that the number of candidate cell sets is 2, and when 3 cells are included in a first cell set, and 4 cells are included in a second cell set, the UE may expect that 4 FDRA fields, which correspond to the maximum number of cells among those included in the first and second cell sets, exist in the MC-DCI.
If the UE has failed to receive a higher-layer signaling configuration, such as the table mentioned in the first method, for all cell sets, the UE may determine, based on the FDRA fields in the MC-DCI, whether scheduling information for each cell exists. If the number of cells in the cell set indicated via the cell set indicator field is less than the number of the FDRA fields, the UE may consider the FDRA fields, which correspond to the number of cells in the indicated cell set, as indexes in ascending order of the FDRA fields, and may disregard FDRA fields corresponding to indexes greater than the number of cells.
If the UE has received a higher-laver signaling configuration, such as the table mentioned in the first method, for a specific cell set, but has failed to receive the same for the remaining cell sets, the UE may expect that the MC-DCI includes a scheduling cell indicator field which may indicate an index of a specific row within the table configured via higher-layer signaling as in the first method. The UE may determine which cell set is indicated via the cell set indicator field in the MC-DCI, and when determining whether scheduling information exists for one or more cells, the UE may use a method of interpreting a scheduling cell indicator field or interpreting an FDRA field. In this case, the scheduling cell indicator field that may be included in the MC-DCI may be a separate field distinct from the carrier indication field (CIF), or the CIF in the MC-DCI may replace the scheduling cell indicator field. If the UE is indicated, via the cell set indicator field in the MC-DCI, a cell set for which higher-layer signaling such as the table has been received, the UE may be indicated, via the scheduling cell indicator field, with whether scheduling information exists for one or more cells. If the UE is indicated, via the cell set indicator field in the MC-DCI, a cell set for which higher-layer signaling such as the table has not been configured, the UE may be indicated, via the FDRA field, whether scheduling information exists for one or more cells.

FIG. 10 is a diagram illustrating an example in which MC-DCI includes multiple FDRA fields according to an embodiment of the disclosure.

Referring to FIG. 10, MC-DCI 1000 may include multiple FDRA fields. In addition, cells corresponding to the respective FDRA fields may exist. That is, when cells which may be co-scheduled via the MC-DCI 1000 are configured as cell 0 1020, cell 1 1021, cell 2 1022, and cell 3 1023, the MC-DCI 1000 may include an FDRA field 1010 for cell 0, an FDRA field 1011 for cell 1, an FDRA field 1012 for cell 2, and an FDRA field 1013 for cell 3. Whether the respective cells have been scheduled may be determined based on values of the FDRA fields. The cells scheduled based on the values of the FDRA fields may be referred to as actually co-scheduled cells.

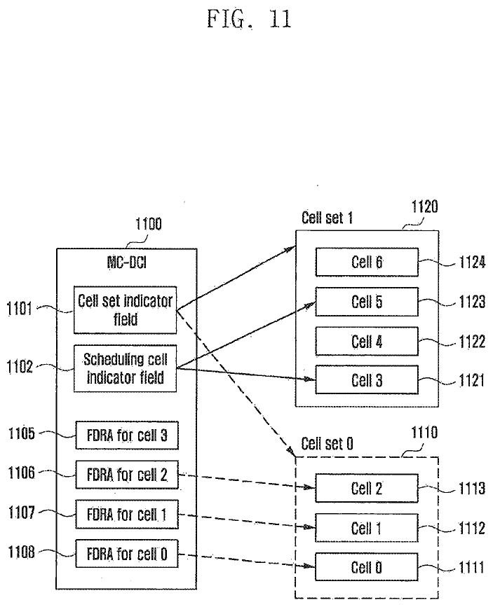

FIG. 11 is a diagram illustrating an example in which MC-DCI includes at least one of a cell set indicator field, a scheduling cell indicator field, and multiple FDRA fields according to an embodiment of the disclosure.

Referring to FIG. 11, MC-DCI 1100 may include at least one of a cell set indicator field 1101, a scheduling cell indicator field 1102, and multiple FDRA fields 1105, 1106, 1107, and 1108. As described above, if the number of candidate cell sets which may be scheduled by receiving the MC-DCI within a specific cell is two or more, and a UE has reported this value to a base station, the UE may expect that the cell set indicator field 1101 exists in the MC-DCI, and if the UE reports that the value is one, the field may not exist. FIG. 11 illustrates a case in which the UE reports the number of candidate cell sets as two, where cell set 0 1110 may include three cells of cell 0 1111, cell 1 1112, and cell 2 1113, and cell set 1 1120 may include cell 3 1121, cell 4 1122, cell 5 1123, and cell 6 1124. Accordingly, the UE may expect that 4 FDRA fields exist in the MC-DCI, wherein 4 is the maximum number of cells included in each of cell set 0 1110 and cell set 1 1120.

In addition, in FIG. 11, a situation has been assumed in which the UE is not configured via higher-layer signaling, such as the table above, for cell set 0 1110. Therefore, as in the second method, the presence or absence of scheduling information for the cells within cell set 0 1110 may be indicated by the FDRA fields 1105, 1106, 1107, and 1108 in the MC-DCI. In this case, since there are three cells within cell set 0 1110, the UE may be indicated with the scheduling information for cell 0 1111, cell 1 1112, and cell 2 1113 via the first, second, and third FDRA fields 1108, 1107, and 1106.

In addition, in FIG. 11, a situation may be assumed in which the UE is configured via higher-layer signaling, such as the table above, for cell set 1 1120. Therefore, as in the first method, the presence or absence of scheduling information for the cells within cell set 1 1120 may be indicated by the scheduling cell indicator field 1102 in the MC-DCI. For example, among all rows in the table configured via higher-layer signaling, the UE may be indicated with a specific row via the scheduling cell indicator field 1102 in the MC-DCI, and the row may indicate, for example, scheduling information for cell 3 1121 and cell 5 1123 within cell set 1 1120.

The UE may receive FDRA fields included in one DCI and determine a cell corresponding to each FDRA field. The UE may determine whether a data channel is scheduled in the cell via an FDRA type and a value of the FDRA field for the cell. The UE may identify whether a cell is scheduled, a scheduled cell, and/or an unscheduled cell, based on one or more of FDRA types and FDRA fields. For example, an FDRA field interpretation method may vary depending on subcarrier spacing of a corresponding cell.

The FDRA field may be classified into a valid value and an invalid value. A valid value may refer to a case in which frequency domain allocation corresponding to a value of the FDRA field exists. Conversely, an invalid value may refer to a case in which frequency domain allocation corresponding to a value of the FDRA field does not exist.

For example, valid and invalid values are described based on FDRA type-0. FDRA type-0 is a method of indicating RBs (or RBGs) scheduled based on a bitmap. Here, there may be corresponding RBs (or RBGs) for each bit. If a bit is “1”, corresponding RBs (or RBGs) may be scheduled, and if the bit is “0”, corresponding RBs (or RBGs) may not be scheduled. Accordingly, at least one bit being “1” may be determined as a valid value, and all bits being “0” may be determined as an invalid value.

For example, valid and invalid values are described based on FDRA type-1. FDRA type-1 is a method of indicating RBs scheduled based on RIV. Here, FDRA type-1 may schedule consecutive RBs in the frequency domain. FDRA type-1 may indicate a starting RB index and the number of consecutive RBs. An RIV value may be one of 0, 1, . . . N*(N+1)/2−1. Here, N is the number of RBs included in the frequency domain (or BWP in which the data channel is scheduled). Accordingly, the RIV value being one of 0, 1, . . . , N*(N+1)/2−1 may be determined as a valid value, and the RIV value being equal to or greater than N*(N+1)/2 may be determined as an invalid value.

Some of the cells scheduled by the MC-DCI may be cells of a licensed band, and the other cells may be cells of an unlicensed band (or shared spectrum). For example, for a cell of an unlicensed band, FDRA type-2 may need to be used for uplink scheduling.

When the UE is configured with FDRA type-2 for a cell, whether the cell is scheduled may be determined based on at least one of the following or any combination thereof.

When the cell has a subcarrier spacing of 15 kHz, the UE may determine that the cell is not scheduled if the value of the FDRA field is as follows.

In a first case, all bits of the FDRA field are “1”.

In a second case, first 6 bits of the FDRA field are all “1”, that is, all the six MSBs of the FDRA field are “1”.

In a third case, last Y bits of the FDRA field are all “1”, that is, all the Y LSBs of the FDRA field are “1”.

When the cell has a subcarrier spacing of 30 kHz., the UE may determine that the cell is not scheduled if the value of the FDRA field is as follows.

In a first case, first 5 bits of the FDRA field are all “0”, and last Y bits are all “1”, that is, all the five MSBs of the FDRA field are “0”, and all the Y LSBs are “1”.

In a second case, all bits of the FDRA field are “0”.

In a third case, the first 5 bits of the FDRA field are all “0”, that is, all the five MSBs of the FDRA field are “0”.

In a fourth case, the last Y bits of the FDRA field are all “1”, that is, all the Y LSBs of the FDRA field are “1”.

Hereinafter, each situation will be described in more detail.

Situation 1: A Case where a Cell has a Subcarrier Spacing of 15 kHz

The UE may identify information on an FDRA type and a subcarrier spacing of each cell included in candidate cell sets scheduled by the MC-DCI. When one of the cells included in candidate cell sets scheduled by the MC-DCI is configured to use FDRA type-2, the UE may identify whether the subcarrier spacing of the cell is 15 kHz (μ=0) or 30 kHz (μ=1). This embodiment may correspond to a case in which the UE has identified that the subcarrier spacing of the cell is 15 kHz (μ=).

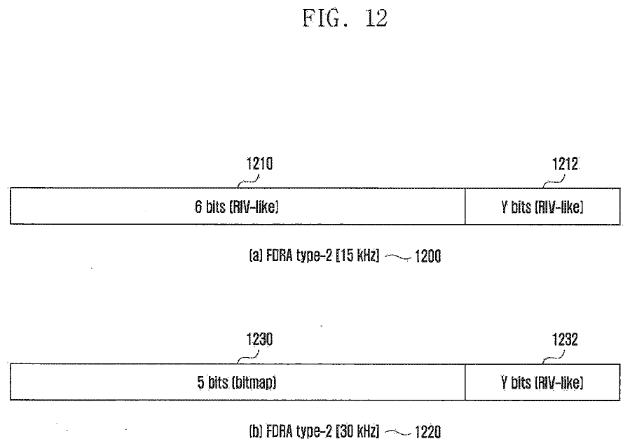

FIG. 12 is a diagram illustrating an example of a field indicating frequency domain resource allocation information according to subcarrier spacing of a cell, according to an embodiment of the disclosure.

Referring to 1200 of FIG. 12, when a subcarrier spacing of a cell is 15 kHz, a length of a field indicating frequency domain allocation information of the cell in MC-DCI may be 6+Y bits. Here, 6 bits 1210 may indicate a starting index (m₀) and a length (L) of M=10 interlaces included in one RB set, Y bits 1212 may indicate a scheduled RB set an may be

$$Y = ⌈ {log}_{2} \frac{{N}_{RB - set , UL}^{BWP} ( {N}_{RB - set , UL}^{BWP} + 1 )}{2} ⌉ .$$

Here, the Y bits may indicate a starting RB set index and a length among RB sets included in a UL BWP. In the disclosure,

$${N}_{RB - set , UL}^{BWP}$$

may be the number of RB sets configured for an indicated active UL BWP. In the disclosure, for convenience, the 6 bits and the Y bits may be referred to as an RIV scheme (or RIV-like).

More specifically, the 6 bits 1210 are as follows.

When μ=0, X=6 MSBs of resource block allocation information (or frequency domain resource allocation information) may indicate interlace index set m₀+l allocated to a UE. Here, the indication of the interlace index set is composed of RIV. If 0≤RIV<M(M+1)/2 where l=0, 1, . . . , L−1, a resource indication value corresponds to starting interlace index m₀ and the number of consecutive interlace indexes. The RIV value is defined as follows.

if (L − 1) ≤ [M/2] then
RIV = M(L-1) + m₀
else

$$RIV = M ( M - L + 1 ) + ( M - 1 - {m}_{0} )$$

For RIV≥M(M+1)/2, the RIV value corresponds to the starting interleaving index m₀ and the 1 value in Table 27 below.

TABLE 27

| RIV − M(M + 1)/2 | m0 | 1 |
|---|---|---|
| 0 | 0 | {0, 5} |
| 1 | 0 | {0, 1, 5, 6} |
| 2 | 1 | {0, 5} |
| 3 | 1 | {0, 1, 2, 3, 5, 6, 7, 8} |
| 4 | 2 | {0, 5} |
| 5 | 2 | {0, 1, 2, 5, 6, 7} |
| 6 | 3 | {0, 5} |
| 7 | 4 | {0, 5} |

Referring to the RIV equation and Table 27 described above, 0, 1, . . . , M(M+1)/2−1(=54) among RIV values may indicate a starting interlace index and the number of consecutive interlace indexes according to the RIV equation, and thereafter, RIV=M(M+1)/2=55, M(M+1)/2+1=56, . . . , M(M+1)/2+7=62 may indicate the starting interlace index (m₀) and the 1 value according to Table 27. The 6 bits of the RIV value may indicate one of 0, 1, . . . , 63, and 0, 1, . . . , 62 are values used for interlace scheduling. However, RIV=63 (6 bits for binary “11111”) may be an unused value. In other words, there may be no scheduled interlace corresponding to the value (RIV=63). Accordingly, a non-scheduled cell may be indicated using the value (RIV=63 (6 bits for binary “11111”)).

More specifically, the Y bits 1212 are as follows.

When μ=0 to μ=1,

$$Y = ⌊ {log}_{2} \frac{{N}_{RB - set , UL}^{BWP} ( {N}_{RB - set , UL}^{BWP} + 1 )}{2} ⌋$$

LSBs of resource block allocation information (or frequency domain resource allocation information) indicate consecutive RB sets for the UE. For example, the Y bits may exist in DCI format 0_1. A resource allocation field is composed of RIV_{RB-set}. For

$$0 \leq {RIV}_{RB - set} < {N}_{RB - set , UL}^{BWP} ( {N}_{RB - set , UL}^{BWP} + 1 ) / 2 ,$$

l=0, 1, . . . , L_{RBset}−1, the resource indication value indicates a starting RB set index

$$( {N}_{RB - set , UL}^{BWP} )$$

the number (L_{RB-set}) of consecutive RB sets. The resource indication value is defined as follows.

$if ( {L}_{R B - s e t} - 1 ) \leq ⌊ {N}_{RB - set , UL}^{B W P} / 2 ⌋ then$
${RIV}_{RB - set} = {N}_{RB - set , UL}^{BWP} ( {L}_{RB - set} - 1 ) + {N}_{RB - set , UL}^{start}$
else
${RIV}_{RB - set} = {N}_{RB - set , UL}^{BWP} ( {N}_{RB - set , UL}^{BWP} - {L}_{RB - set} + 1 ) + ( {N}_{RB - set , UL}^{BWP} - 1 -$
${N}_{RB - set , UL}^{start} )$
$where , {N}_{RB - set , UL}^{start} = 0 , 1 , … , {N}_{RB - set , UL}^{BWP} - 1 , {L}_{RB - set} \geq 1 , and shall not$
$exceed {N}_{RB - set , UL}^{BWP} - {N}_{RB - set , UL}^{start}$

Referring to the equation, the following may be observed.
When one RB set is included in the UL BWP

$$( {N}_{RB - set , UL}^{BWP} = 1 ) ,$$

Y=0 bit(s) (Y=0). Therefore, when Y=0 bit(s), a non-scheduled cell may not be indicated by the Y bit(s).
When two RB sets are included in the UL BWP

$$( {N}_{RB - set , UL}^{BWP} = 2 ) ,$$

Y=2 bits (Y=2). Here, RIV_{RB-set}=0, 1, 2 may be used to indicate a starting RB set index and the number of consecutive RB sets. The Y bit(s) may have values of 0, 1, . . . , 3. Accordingly, there may be no scheduled RB set corresponding to Y bits=3 (both 2 bits are “11”, 2 bits for binary “11”). Therefore, a non-scheduled cell may be indicated using the value (3 (2 bits for binary “11”)).
When three RB sets are included in the UL BWP

$$( {N}_{RB - set , UL}^{BWP} = 3 ) ,$$

Y=3 bits (Y=3). Here, RIV_{RB-set}=0, 1, 2, 3, 4, 5 may be used to indicate a starting RB set index and the number of consecutive RB sets. The Y bit(s) may have values of 0, 1, . . . , 7. Accordingly, there may be no scheduled RB set corresponding to Y bits=7 (all 3 bits are “111”, 3 bits for binary “111”). Therefore, a non-scheduled cell may be indicated using the value (7 (3 bits for binary “111”)).
When 4 RB sets are included in the UL BWP

$$( {N}_{RB - set , UL}^{BWP} = 4 ) ,$$

Y=4 bits (Y=4). Here, RIV_{RB-set}=0, 1, . . . , 9 is used to indicate a starting RB set index and the number of consecutive RB sets. The Y bit(s) may have values of 0, 1, . . . , 15. Accordingly, there may be no scheduled RB set corresponding to Y bits=15 (all 4 bits are “1111”, 4 bits for binary “1111”). Therefore, a non-scheduled cell may be indicated using the value (15 (4 bits for binary “1111”)).
When five RB sets are included in the UL BWP

$$( {N}_{RB - set , UL}^{BWP} = 5 ) ,$$

Y=4 bits (Y=4). Here, RIV_{RB-set}=0, 1, . . . , 14 is used to indicate a starting RB set index and the number of consecutive RB sets. The Y bit(s) may have values of 0, 1, . . . , 15. Accordingly, there may be no scheduled RB set corresponding to Y bits=15 (all 4 bits are “1111”, 4 bits for binary “1111”). Therefore, a non-scheduled cell may be indicated using the value (15 (4 bits for binary “1111”)).

In summary, for the cases remaining after excluding the case where the size of Y bit(s) is 0 (Y=0), if all the Y bits are “1”, a non-scheduled cell may be indicated. That is, when all bits included in the Y LSBs of FDRA are “1”, a non-scheduled cell may be indicated.

In the disclosure, a method of indicating that a cell having a subcarrier spacing of 15 kHz is not scheduled may be at least one of the following or any combination thereof. In the description of the method, the FDRA field is a field corresponding to a cell having a subcarrier spacing of 15 kHz. And an FDRA type may be FDRA type-2.
As a first method, the UE may determine whether the cell is scheduled, based on all bits (6+Y bits) of the FDRA field. For example, if all the bits of the FDRA field are “1”, the UE may determine that the cell is a non-scheduled cell. Here, the FDRA field may include 6 MSBs and Y LSBs. Accordingly, when all the 6+Y bits are “1” (when all bit values of bits included in the 6+Y bits are “1”), the UE may determine that the cell having a subcarrier spacing of 15 kHz and corresponding to the FDRA field is not scheduled.

For example, when all the 6 MSBs are “1”, and all the Y LSBs are not “1” (that is, when all bit values of bits included in the 6 MSBs are I and bit values of at least some of bits included in the Y LSBs are 0, or when all bit values of the bits included in the 6 MSBs are “1” and all bit values of the bits included in the Y LSBs are “0”), the UE may determine that a DCI format including the information is an error case. Alternatively, when all the Y LSBs are “1”, and the remaining 6 MSBs are not all “1” (when all bit values of bits included in the Y LSBs are 1 and bit values of at least some of bits included in the 6 MSBs are 0, or when all bit values of the bits included in the Y LSBs are “1” and all bit values of the bits included in the 6 MSBs are “0”), the UE may determine that a DCI format including the information is an error case. When an error case is determined, the UE may discard (or ignore) information indicated by the DCI format without applying the information. Alternatively, when an error case is determined, the UE may not apply and discard information on the cell (cell corresponding to the FDRA field determined as an error case) among information indicated by the DCI format, and may apply information on the remaining cells (cells remaining after excluding the cell corresponding to the FDRA field determined as an error case).
As a second method, the UE may determine whether the cell is scheduled, based only on 6 MSBs of the FDRA field. The UE may identify whether the cell is scheduled, via the 6 MSBs of the FDRA field. For example, if all bits of the 6 MSBs of the FDRA field are “1” (if bit values of all the bits included in the 6 MSBs are 1), the UE may determine that the cell (cell corresponding to the FDRA field) is a non-scheduled cell. Accordingly, when all the 6 MSBs are “1”, the UE may determine that the cell having a subcarrier spacing of 15 kHz and corresponding to the FDRA field is not scheduled. For example, in this case, bits of Y LSBs may not provide information. That is, regardless of the values of the Y LSBs, whether the cell is scheduled may be determined based on the 6 MSBs. For example, the Y LSBs may be discarded or ignored, or may not be included in the FDRA field (e.g., Y may be 0 (Y=0)).
As a third method, the UE may determine whether the cell is scheduled, based only on Y LSBs of the FDRA field. The UE may identify, whether the cell is scheduled, via the Y LSBs of the FDRA field. For example, if all bits of the Y LSBs of the FDRA field are “1” (if bit values of all the bits included in the Y LSBs are 1), the UE may determine that the cell (cell corresponding to the FDRA field) is a non-scheduled cell. Accordingly, when all the Y LSBs are “1”, the UE may determine that the cell having a subcarrier spacing of 15 kHz and corresponding to the FDRA field is not scheduled. For example, in this case, the bits of the 6 MSBs may not provide information. That is, regardless of the values of the 6 MSBs, whether the cell is scheduled may be determined based on the Y LSBs. For example, the 6 MSBs may be discarded or ignored, or may not be included in the FDRA field.

According to an embodiment, the third method may be used when Y>0. If Y=0, the second method may be used. That is, based on the value of Y, either the second method or the third method may be selectively used. That is, a method to be used by the UE may be determined based on the value of Y (the bit size of the Y LSBs of the FDRA field).

Situation 2: A Case where a Cell has a Subcarrier Spacing of 30 kHz

The UE may identify information on an FDRA type and a subcarrier spacing of each cell included in candidate cell sets scheduled by the MC-DCI. If one of cells included in the candidate cell sets scheduled by the MC-DCI is configured with FDRA type-2, the UE may identify whether the subcarrier spacing of the cell is 15 kHz (μ=0) or 30 kHz (μ=1). This embodiment may correspond to a case in which the UE has identified that the subcarrier spacing of the cell is 30 kHz (μ=1).

In 1220 of FIG. 12, an embodiment of a field indicating frequency domain resource allocation information when a subcarrier spacing of a cell is 30 kHz is illustrated.

Referring to 1220 of FIG. 12, when a subcarrier spacing of a cell is 30 kHz, a length of a field indicating frequency domain allocation information of the cell in MC-DCI may be 5+Y bits. Here, 5 bits 1230 may indicate, in a bitmap, whether M=5 interlaces included in one RB set are scheduled. That is, each of the 5 bits may be used to indicate whether one interlace is scheduled. Here, an interlace corresponding to a bit having a value of “1” among the 5 bits may be determined to be scheduled. An interlace corresponding to a bit having a value of “0” among the 5 bits may be determined to be not scheduled. Y bits 1232 indicate a scheduled RB set, and is

$$Y = ⌈ {log}_{2} \frac{{N}_{RB - set , UL}^{BWP} ( {N}_{RB - set , UL}^{BWP} + 1 )}{2} ⌉ .$$

Here, the Y bits may indicate a starting RB set index and a length among RB sets included in a UL BWP. In the disclosure,

$${N}_{RB - set , UL}^{BWP}$$

may be the number of RB sets configured for an indicated active UL BWP. In the disclosure, for convenience, the 5 bits may be referred to as a bitmap scheme, and the Y bits may be referred to as an RIV scheme (or RIV-like).

The 5 bits may indicate interlaces scheduled based on a bitmap. If each of the 5 bits is “1”, the UE may determine that an interlace corresponding to “1” is scheduled. Here, the interlace corresponding to a bit having a value of “1” among the 5 bits may be determined to be scheduled. If all of the 5 bits are “0”, there may be no scheduled interlace. Accordingly, when all of the 5 bits are “0”, the 5 MSBs may be used to determine that the cell is not scheduled.

Since the Y bits in situation 2 are the same as those in embodiment 1 described above, the detailed description thereof is omitted, and reference may be made to the description of the Y bits in situation 1.

The FDRA field of the cell having a subcarrier spacing of 30 kHz includes 5+Y bits, in which the 5 MSBs indicate interlaces scheduled within an RB set in a bitmap scheme, and the Y LSBs indicate scheduled RB sets in an RIV scheme. Accordingly, whether the cell is scheduled may be determined based on the values of the 5 MSBs and the Y LSBs.

In the disclosure, a method of indicating that a cell having a subcarrier spacing of 30 kHz is not scheduled may be at least one of the following or any combination thereof. In the description of the method, the FDRA field is a field corresponding to a cell having a subcarrier spacing of 30 kHz. In addition, an FDRA type may be FDRA type-2.
As a first method, the UE may determine whether the cell is scheduled, based on all bits (5+Y bits) of the FDRA field. For example, if all the bits of the FDRA field are “0”, the UE may determine that the cell having a subcarrier spacing of 30 kHz is a non-scheduled cell. Here, the FDRA field may include 5 MSBs and Y LSBs. Accordingly, when all the 5+Y bits are “0” (when all bit values of bits included in the 5+Y bits are “0”), the UE may determine that the cell having a subcarrier spacing of 30 kHz and corresponding to the FDRA field is not scheduled. For example, if all the Y LSBs are “0”, a corresponding value may exist according to the RIV_{RB-set} equation. However, since all the 5 MSBs are “0”, the RB set indicated by the Y LSBs may not be used as information on whether scheduling is performed. That is, since it is determined that there is no scheduled interlace due to all the 5 MSBs being “0”, the RB set corresponding to the Y LSBs may be ignored.
As a second method, the UE may determine whether the cell is scheduled, based only on 5 MSBs of the FDRA field. The UE may identify whether the cell is scheduled, via the 5 MSBs of the FDRA field. For example, if all bits of the 5 MSBs of the FDRA field are “0” (if bit values of all the bits included in the 5 MSBs are 1), the UE may determine that the cell (cell corresponding to the FDRA field) is a non-scheduled cell. Accordingly, when all the 5 MSBs are “0”, the UE may determine that the cell having a subcarrier spacing of 30 kHz and corresponding to the FDRA field is not scheduled. For example, in this case, bits of Y LSBs may not provide information. That is, regardless of the values of the Y LSBs, whether the cell is scheduled may be determined based on the 5 MSBs. For example, the Y LSBs may be discarded or ignored, or may not be included in the FDRA field (e.g., Y may be 0 (Y=0)).
As a third method, the UE may determine whether the cell is scheduled, based only on Y LSBs of the FDRA field. The UE may identify whether the cell is scheduled, via the Y LSBs of the FDRA field. For example, if all bits of the Y LSBs of the FDRA field are “1” (if bit values of all the bits included in the Y LSBs are 1), the UE may determine that the cell (cell corresponding to the FDRA field) is a non-scheduled cell. Accordingly, when all the Y LSBs are “1”, the UE may determine that the cell having a subcarrier spacing of 30 kHz and corresponding to the FDRA field is not scheduled. For example, in this case, the bits of the 5 MSBs may not provide information. That is, regardless of the values of the 5 MSBs, whether the cell is scheduled may be determined based on the Y LSBs. For example, the 5 MSBs may be discarded or ignored, or may not be included in the FDRA field.

According to an embodiment, the third method may be used when Y>0. If Y=0, the second method may be used. That is, based on the value of Y, either the second method or the third method may be selectively used. That is, a method to be used by the UE may be determined based on the value of Y (the bit size of the Y LSBs of the FDRA field).

### Embodiment 2: PUSCH Transmission Method of an 8TX UE

In an embodiment of the disclosure, a method in which a UE supporting 8 transmission antennas for transmitting uplink channels and signals transmits a PUSCH will be described. This embodiment may be implemented in combination with all other embodiments of the disclosure.

The 8 transmission antennas for uplink may refer to 8 physical antennas or may refer to a case in which, although the UE actually has 8 or more (or fewer) physical antennas, 8 logical uplink transmission ports are configured via a method of virtualizing multiple antennas into a single antenna. However, according to various embodiments of the disclosure, the number of transmission antennas for uplink is not limited, and all cases in which a UE may be assumed to have 8 transmission antennas via other antenna configuration methods may be included. In addition, a case where the number of transmission antennas is fewer than or more than 8 (e.g., 6, 12, 16, or any greater number) may also correspond to a case where the embodiment of the disclosure is applicable.

A UE supporting 4 transmission antennas may perform PUSCH transmission using up to 4 layers via CP-OFDM waveform-based uplink data channel transmission, and the up to 4 layers may be included in one codeword (CW) (or the up to 4 layers may be used to transmit one CW). That is, modulation symbols of one CW may be mapped to 4 layers. Hereinafter, the description that a specific layer is included in a CW may be understood to indicate that modulation symbols of the CW are mapped to the specific layer. In later NR releases (e.g., NR Release 18), a UE supporting 8 transmission antennas for performance enhancement, such as maximum uplink throughput of a UE including a fixed wireless access (FWA) UE or customer premises equipment (CPE) having an improved form factor compared to a UE such as a smartphone that may have a relatively smaller size and performance, may perform PUSCH transmission using up to 8 layers via CP-OFDM waveform-based uplink data channel transmission.

If the UE is scheduled with a PUSCH including 5 layers by the base station, the UE may include first and second layers in a first CW and include third to fifth layers in a second CW.

If the UE is scheduled with a PUSCH including 6 layers by the base station, the UE may include first to third layers in the first CW and include fourth to sixth layers in the second CW.

If the UE is scheduled with a PUSCH including 7 layers by the base station, the UE may include first to third layers in the first CW and include fourth to seventh layers in the second CW.

If the UE is scheduled with a PUSCH including 8 layers by the base station, the UE may include first to fourth layers in the first CW and include fifth to eighth layers in the second CW.

If the UE transmits a PUSCH to the base station, a PUSCH transmission scheme of the UE may be classified into “codebook”-based PUSCH transmission and “non-codebook”-based PUSCH transmission. When the UE performs “codebook”-based PUSCH transmission, the UE may transmit SRS resource(s) which may consist of multiple SRS ports (or may consist of a single SRS port), to the base station, and the base station may receive the same to perform estimation on an uplink channel. Thereafter, based on uplink channel information acquired via the received SRS resources, the base station may select one SRS resource among multiple SRS resources (when the multiple SRS resources are received) and indicate the selected SRS resource via an SRI in DCI for PUSCH scheduling. In this case, when the UE interprets the SRI indicated via the DCI received from the base station, the UE may consider that an SRS resource ID which may be indicated via the SRI corresponds to a most recently transmitted SRS resource before receiving the DCI among multiple transmission positions for the SRS resource having the corresponding SRS resource ID.

In addition, the base station may select, based on the selected SRS resource, the number of layers and precoder of the uplink data channel, and determine a TPMI field within the same PUSCH scheduling DCI including the SRI field. If the UE supports 4 transmission antennas, a row of the precoder indicated by a TPMI may represent a PUSCH antenna port (for example, in [a b c d]^{T}, a, b, c, and d may represent values for first, second, third, and fourth PUSCH antenna ports, respectively.) and may include up to 4 rows. If the UE supports 8 transmission antennas as described above, according to an embodiment, when up to 8 PUSCH antenna ports, rather than up to 4 PUSCH antenna ports, are used to support a codebook-based uplink data channel (an uplink control channel may also be included), not only a codebook supportable up to 4 PUSCH antenna ports but also a codebook supportable up to 8 PUSCH antenna ports may be required.

In addition, for PUSCH transmission including 5 or more layers, the UE may expect that two modulation and coding scheme (MCS) fields, two redundancy version (RV) fields, and two new data indicator (NDI) fields are included in the DCI for PUSCH scheduling received from the base station. If the UE receives, via the DCI from the base station, scheduling information for PUSCH transmission including 5 or more layers, that is, when the UE is scheduled for PUSCH transmission consisting of two codewords from the base station, the UE may understand that a first MCS field, a first RV field, and a first NDI field in the DCI are applied to the first CW, and a second MCS field, a second RV field, and a second NDI field are applied to the second CW. In this case, a condition that two MCS fields, two RV fields, and two NDI fields exist in DCI formats 0_1 and 0_2 may correspond to a case where the UE has received specific higher-layer signaling from the base station (for example, a case where the UE receives signaling distinct from maxNrofCodeWordsScheduledByDCI which is higher-layer signaling indicating that PDSCH reception of up to 8 layers is possible, such as maxNrofCodeWordsScheduledByDCI-PUSCH, a case where higher-layer signaling indicating that PDSCH reception of up to 8 layers is possible may be commonly applied to the UE, or a case where a parameter value for a maximum rank value of PUSCH, which may be configured for the UE via higher-layer signaling by the base station, is 5 or greater).

If the UE receives PUSCH scheduling for two CWs from the base station, the UE may assume that two different transport blocks (TBs) are transmitted for the PUSCH. If the UE receives a 26th index for the first MCS field, receives an RV index of 1 for the first RV field, and receives 0 or I for the first NDI field, the UE may consider that a first TB is not transmitted (is disabled). If the UE receives a 26th index for the second MCS field, receives an RV index of I for the second RV field, and receives 0 or 1 for the second NDI field, the UE may consider that a second TB is not transmitted (is disabled). As such, if, due to the first or second TB not being transmitted from the UE, the UE performs transmission of only one TB, the UE may include the transmitted one TB in the first CW of the PUSCH.

The UE may be scheduled for PUSCH transmission including up to 8 layers for one or more cells via the MC-DCI (e.g., DCI format 0_X or 0_3), and to this end, the UE may be configured with specific higher-layer signaling from the base station. The higher-layer signaling may be one of the following.
Higher-layer signaling such as higher-layer signaling related to DCI format 0_1 or 0_2 (for example, a case where, similar to DCI format 0_1 or 0_2, the higher-layer signaling may be separate higher-layer signaling distinct from maxNrofCodeWordsScheduledByDCI which is higher-layer signaling indicating that PDSCH reception of up to 8 layers is possible, such as maxNrofCodeWordsScheduledByDCI-PUSCH, a case where higher-layer signaling for PDSCH may also be commonly applied to PUSCH, or a case where a parameter value for a maximum rank value of PUSCH, which may be configured for the UE via higher-layer signaling by the base station, is 5 or greater.) may be configured in a cell where the UE receives MC-DCI, or in each of one or more cells which may be scheduled for the UE via the MC-DCI.
Additional higher-layer signaling for supporting up to 8 layers in the MC-DCI, which is distinct from the higher-layer signaling corresponding to DCI formats 0_1 or 0_2, may be configured in a cell where the UE receives the MC-DCI, or in each of one or more cells which may be scheduled for the UE via the MC-DCI.

If the UE can be scheduled, via the MC-DCI (e.g., DCI format 0_X or 0_3), for PUSCH transmission including up to 4 layers for one or more cells, that is, when only scheduling for PUSCH transmission consisting of one CW is possible, as many MCS fields, RV fields, and NDI fields as the number of cells which may be scheduled via the MC-DCI may be included in the MC-DCI. For example, if the UE can receive scheduling for up to 4 different cells, the UE may expect that 4 MCS fields, 4 RV fields, and 4 NDI fields are included in the MC-DCI, and may expect that 1 MCS field, 1 RV field, and 1 NDI field may be used per cell for which the UE may receive scheduling information via the MC-DCI.

In this case, if multiple MCS fields exist in the MC-DCI, the sizes of all the MCS fields may be the same, that is, 5 bits. In this case, if multiple RV fields exist in the MC-DCI, the size of each RV field may differ for each cell which may be scheduled for the UE via the MC-DCI, and the UE may determine the size of each RV field for each cell via higher-layer signaling from the base station, where the size of the RV field may be 0, 1, or 2 bits. In this case, if multiple NDI fields exist in the MC-DCI, the sizes of all the NDI fields may be the same, that is, 1 bit. In this case, if multiple MCS fields, RV fields, and NDI fields exist in the MC-DCI, the UE may expect that, as the order of the respective fields within the MC-DCI, the multiple MCS fields are placed first, the multiple RV fields are placed subsequently, and then the multiple NDI fields are placed.

If the UE can be scheduled, via the MC-DCI (e.g., DCI format 0_X or 0_3), for PUSCH transmission including up to 8 layers for one or more cells, twice the number of MCS fields, RV fields, and NDI fields as the number of cells which may be scheduled via the MC-DCI may be included in the MC-DCI. For example, if the UE can receive scheduling for up to 4 different cells, the UE may expect that 8 MCS fields. 8 RV fields, and 8 NDI fields are included in the MC-DCI, and may expect that 2 MCS fields, 2 RV fields, and 2 NDI fields may be used per cell for which the UE may receive scheduling information via the MC-DCI.

In this case, if multiple MCS fields exist in the MC-DCI, the sizes of all the MCS fields may be the same, that is, 5 bits. In this case, if multiple RV fields exist in the MC-DCI, the size of each RV field may differ for each cell which may be scheduled for the UE via the MC-DCI, and the UE may determine the size of each RV field for each cell via higher-layer signaling from the base station, where the size of the RV field may be 0, 1, or 2 bits. In addition, when 2 RV fields exist as described above for one cell which may be scheduled via the MC-DCI, that is, when the UE is scheduled for PUSCH consisting of two CWs, the UE may expect, via the higher-layer signaling regarding the sizes of the RV fields of each cell, that the 2 RV fields corresponding to one cell have the same size, or that higher-layer signaling regarding the size of each of the 2 RV fields for one cell exists individually, so that the two RV fields corresponding to one cell have the same size or have different sizes. In this case, if multiple NDI fields exist in the MC-DCI, the sizes of all the NDI fields may be the same, that is, 1 bit.

In this case, if multiple MCS fields, RV fields, and NDI fields exist in the MC-DCI, the UE may expect that, as the order of the respective fields within the MC-DCI, multiple MCS fields corresponding to the first TB scheduled for each cell are placed first, multiple RV fields corresponding to the first TB scheduled for each cell are placed subsequently, multiple NDI fields corresponding to the first TB scheduled for each cell are placed subsequently, multiple MCS fields corresponding to the second TB scheduled for each cell are placed subsequently, multiple RV fields corresponding to the second TB, are placed subsequently, and then multiple NDI fields corresponding to the second TB scheduled for each cell are placed.

The UE may be configured, via higher-layer signaling by the base station, whether one antenna port field (e.g., an antenna port(s) field) exists in the MC-DCI (e.g., DCI format 0_X or 0_3), or whether there exist as many independent fields as the number of different cells which may be scheduled for the UE via the MC-DCI. If the UE has been configured, via higher-layer signaling by the base station, that one antenna port field exists in the MC-DCI, the UE may commonly apply information on a PUSCH DMRS port indicated via the one antenna port field to a PUSCH of one or more cells which may be scheduled for the UE via the MC-DCI. In this case, the size of the one antenna port field may correspond to the largest size among sizes of the antenna port field, which are required for PUSCH scheduling of each cell, according to higher-layer signaling for each cell which may be scheduled for the UE via the MC-DCI.

If the UE has been configured, via higher-layer signaling by the base station, that as many antenna port fields as the number of different cells which may be scheduled via the MC-DCI exist in the MC-DCI, the UE may apply the multiple antenna port fields to the respective different cells which may be scheduled via the MC-DCI. In this case, the UE may expect that the size of the antenna port field corresponding to each cell is determined according to higher-layer signaling for each cell which may be scheduled via the MC-DCI.

The UE may be configured, via higher-layer signaling by the base station, whether one TPMI field (e.g., a precoding information and number of layers field) exists in the MC-DCI (e.g., DCI format 0_X or 0_3), or whether as many TPMI fields as the number of different cells which may be scheduled for the UE via the MC-DCI exist as independent fields. If the UE has been configured, via higher-layer signaling by the base station, that one TPMI field exists in the MC-DCI, the UE may commonly apply information on a PUSCH DMRS port indicated via the one TPMI field to a PUSCH of one or more cells which may be scheduled for the UE via the MC-DCI. In this case, the size of the one TPMI field may correspond to the largest size among sizes of the TPMI field, which are required for scheduling of each cell, according to higher-layer signaling for each cell which may be scheduled for the UE via the MC-DCI.

If the UE has been configured, via higher-layer signaling by the base station, that as many TPMI fields as the number of different cells which may be scheduled via the MC-DCI exist in the MC-DCI, the UE may apply the multiple TPMI fields to PUSCHs of the respective different cells which may be scheduled via the MC-DCI. In this case, the UE may expect that the size of the TPMI field corresponding to each cell is determined according to higher-layer signaling for each cell which may be scheduled via the MC-DCI.

The UE may expect that as many phase tracking reference signal (PTRS)-DMRS association fields as the number of different cells which may be scheduled for the UE via the MC-DCI exist as independent fields in the MC-DCI (e.g., DCI format 0_X or 0_3).

The UE may expect that one DMRS sequence initialization field exists in the MC-DCI (e.g., DCI format 0 X or 0_3), and the UE may commonly apply information on DMRS sequence initialization indicated via the one DMRS sequence initialization field to one or more cells which may be scheduled for the UE via the MC-DCI.

At least one of the aforementioned MC-DCI configurations or any combination thereof is applicable to MC-DCI.

### Embodiment 3: Method of Configuring a Waveform Change Indicator in MC-DCI

In an embodiment of the disclosure, a method of configuring a waveform change indicator that may exist within MC-DCI will be described. The embodiment may be implemented in combination with other embodiments.

For a UE, a PUSCH waveform change indicator field may be included in DCI formats 0_1 and 0_2. To this end, UE capability reporting from a corresponding UE and a higher-layer signaling configuration from a base station may be required. The PUSCH waveform change indicator may be 1 bit, and when a value of the field is 0, a PUSCH scheduled via the DCI may be transmitted based on a DFTS-OFDM waveform, and when the value of the field is 1, a PUSCH scheduled via the DCI may be transmitted based on a CP-OFDM waveform. The definition of each bit value of the field may be reversed so that, when the value of the field is 1, the UE may perform PUSCH transmission based on a DFTS-OFDM waveform, and when the value of the field is 0, the UE may perform PUSCH transmission based on a CP-OFDM waveform.

If no higher-layer signaling indicating that the PUSCH waveform change indicator field is included in DCI formats 0_1 and 0_2 is configured for the UE by the base station, the UE may determine, via a parameter referred to as transformPrecoder configured in higher-layer signaling PUSCH-Config within BWP, whether to use CP-OFDM or use DFTS-OFDM for PUSCH transmission dynamically scheduled via DCI format 0_1 or 0_2.
If the UE is configured with transformPrecoder in PUSCH-Config being enabled, the UE may use a DFTS-OFDM waveform for PUSCH transmission dynamically scheduled via DCI format 0_1 or 0_2.
If the UE is configured with transformPrecoder being disabled, the UE may use a CP-OFDM waveform for PUSCH transmission dynamically scheduled via DCI format 0_1 or 0_2.

Via a parameter referred to as transformPrecoder configured in higher-layer signaling configuredGrantConfig within BWP, when configured grant type 2-based PUSCH transmission is enabled via DCI format 0_1 or 0_2, or configured grant type 1-based PUSCH transmission is configured via higher-layer signaling, the UE may determine whether to use CP-OFDM or DFTS-OFDM.
If the UE is configured with transformPrecoder in configuredGrantConfig being enabled, when configured grant type 2-based PUSCH transmission is enabled by the base station via DCI format 0_1 or 0_2, or configured grant type 1-based PUSCH transmission is configured by the base station via higher-layer signaling, the UE may use a DFTS-OFDM waveform.
If the UE is configured with transformPrecoder being disabled, when configured grant type 2-based PUSCH transmission is enabled by the base station via DCI format 0_1 or 0_2, or configured grant type 1-based PUSCH transmission is configured by the base station via higher-layer signaling, the UE may use a CP-OFDM waveform.

If configured grant type 2-based PUSCH transmission is enabled for the UE via DCI format 0_1 or 0_2, or PUSCH transmission is dynamically scheduled for the UE, the UE may expect, in each case where transformPrecoder in configuredGrantConfig or transformPrecoder in PUSCH-Config is configured to be enabled or disabled as described above, that the antenna port field, TPMI field, PTRS-DMRS association field, and DMRS sequence initialization field in DCI formats 0_1 or 0_2 have different bit lengths as shown below.
For example, if the UE uses a DFTS-OFDM waveform for PUSCH transmission according to the higher-layer signaling configuration, a bit length of the antenna port field can be from a minimum of 2 bits to a maximum of 4 bits, and a bit length of the TPMI field can be from a minimum of I bit to a maximum of 5 bits according to the higher-layer signaling configuration within BWP.
For another example, if the UE uses a CP-OFDM waveform for PUSCH transmission according to the higher-layer signaling configuration, a bit length of the antenna port field can be from a minimum of 3 bits to a maximum of 5 bits, and a bit length of the TPMI field can be from a minimum of I bit to a maximum of 6 bits according to the higher-layer signaling configuration within BWP.

If higher-layer signaling indicating that the PUSCH waveform change indicator field is included in DCI formats 0_1 and 0_2 is configured for the UE by the base station, the UE may use, for each field, a bit length corresponding to a largest value among bit sizes determined according to a specific PUSCH waveform as described above.
For example, with respect to the antenna port field, when the UE has, as above, a length of 3 bits when using DFTS-OFDM and has 5 bits when using CP-OFDM, and if the PUSCH waveform change indicator field is included in DCI formats 0_1 and 0_2, the UE may expect that the antenna port field in the DCI formats 0_1 and 0_2 has the length of 5 bits which corresponds to the largest value among 3 bits and 5 bits.
For another example, with respect to the TPMI field, when the UE has, as above, a length of 2 bits when using DFTS-OFDM and has 5 bits when using CP-OFDM, and if the PUSCH waveform change indicator field is included in DCI formats 0_1 and 0_2, the UE may expect that the TPMI field in the DC formats 0_and 0_2 has the length of 5 bits which corresponds to the largest value among 2 bits and 5 bits.

Similarly, with respect to the antenna port field, the TPMI field, the PTRS-DMRS association field, and the DMRS sequence initialization field, the UE may determine a bit length of each field by using a largest value among bit lengths for each waveform.

For a UE, a PUSCH waveform change indicator field may be included in MC-DCI for uplink scheduling, which is referred to as DCI format 0_X or DCI format 0_3. To this end, UE capability reporting from a corresponding UE and a higher-layer signaling configuration from a base station may be required. The UE may assume a format of the PUSCH waveform change indicator field within the MC-DCI via various methods as described below.

### [Method 1]

The UE may expect that one PUSCH waveform change indicator field with a length of I bit is included in MC-DCI, and may determine all PUSCH waveforms within BWPs of all cells scheduled via the MC-DCI to be the same based on one bit value of 0 or 1. For example, as in the above, when the value of the PUSCH waveform change indicator in the MC-DCI is 0, all PUSCHs within BWPs of all cells scheduled via the MC-DCI may be transmitted based on a DFTS-OFDM waveform, and when the value of the field is 1, all PUSCHs within all cells scheduled via the MC-DCI may be transmitted based on a CP-OFDM waveform. The definition of each bit value of the field may be reversed so that, when the value is 1, the UE may perform PUSCH transmission based on a DFTS-OFDM waveform, and when the value is 0, the UE may perform PUSCH transmission based on a CP-OFDM waveform.

Additionally, when the PUSCH waveform change indicator field in the MC-DCI is defined to be 1 bit, the UE may consider that PUSCH waveforms within a specific BWP of one or more specific cells scheduled via the MC-DCI is determined to be the same, in which case, the specific cell may correspond to a cell for which the UE has received higher-layer signaling indicating that the PUSCH waveform change indicator field may be applied to the cell, and the specific BWP may correspond to a BWP for which the UE has received higher-layer signaling indicating that the PUSCH waveform change indicator field may be applied to the BWP.

In this case, the UE may determine that the PUSCH waveform change indicator field exists in the MC-DCI and/or the field has a length of 1 bit, based on a parameter configurable via higher-layer signaling within the cell in which the MC-DCI is received or a parameter configurable via higher-layer signaling within the BWP of the cell in which the MC-DCI is received.

### [Method 2]

The UE may expect that one PUSCH waveform change indicator field having a length of 1 bit or more is included in MC-DCI, and each codepoint of the PUSCH waveform change indicator field may include waveform change information for each cell which may be scheduled via the MC-DCI. Each codepoint may exist in the format of a list for waveform change indication, and one or more lists may be configured for the UE via higher-layer signaling by the base station. For example, waveform list 1 that is a list for waveform change indication corresponding to a specific codepoint may have a format, such as {CP-OFDM, DFTS-OFDM, CP-OFDM, DFTS-OFDM}, and this list may indicate to perform PUSCH transmission by applying CP-OFDM to first and third cells which may be scheduled via the MC-DCI and applying DFTS-OFDM to second and fourth cells which may be scheduled via the MC-DCI.

Alternatively, each codepoint of the PUSCH waveform change indicator field may include waveform change information for a specific cell group which may be scheduled via the MC-DCI. In this case, the specific cell group may be configured for the UE via higher-layer signaling by the base station, and the specific cell group may be a concept different from or identical to a cell set. When the specific cell group is a concept different from a cell set, the specific cell group may include some of all cells in a cell set. For example, if there are 4 cells in a cell set, 2 cells in the cell set may form one cell group, and the remaining 2 cells may form another cell group. In this case, each codepoint of the MC-DCI may exist in the format of a list for waveform change indication, one or more lists may be configured for the UE via higher-layer signaling by the base station, and each list may include as many pieces of waveform change information as the number of cell groups. For example, when two cell groups exist in the cell set as described above, waveform list I that is a list for waveform change indication corresponding to a specific codepoint may have a format, such as {CP-OFDM, DFTS-OFDM}, and this list may indicate to perform PUSCH transmission by applying CP-OFDM to the first cell group which may be scheduled via the MC-DCI and applying DFTS-OFDM to the second cell group which may be scheduled via the MC-DCI.

The bit length of the PUSCH waveform change indicator field in the MC-DCI may be determined according to the number of lists for waveform change indication, and if the number of lists is N, the bit length may be, for example, determined as ceil(log 2(N)). Here, ceil(.) may denote a ceiling function, and log 2(.) may denote a logarithmic function with a base of 2.

In addition, a value such as “none”, “void”, or “empty” may be configured in the list, and the value may indicate that no dynamic waveform switching indication is performed for a corresponding cell and a waveform is determined according to a higher-layer signaling configuration within a corresponding cell and a corresponding BWP.

In this case, the UE may determine that the PUSCH waveform change indicator field exists in the MC-DCI and/or the field has a length of 1 bit or more, based on a parameter configurable via higher-layer signaling within the cell in which the MC-DCI is received or a parameter configurable via higher-layer signaling within the BWP of the cell in which the MC-DCI is received.

### [Method 3]

The UE may expect that one PUSCH waveform change indicator field with a length of 1 bit is included in MC-DCI, and may determine, based on one bit value of 0 or 1, a waveform of a PUSCH within a BWP in a specific cell scheduled via the MC-DCI. The specific cell may be a first cell or a last cell among all cells scheduled via the MC-DCI, or a cell of a specific index according to higher-layer signaling configured for the UE by the base station. In this case, there may be at least one cell having a specific index according to higher-layer signaling. In this case, when the value of the PUSCH waveform change indicator in the MC-DCI is 0, the PUSCH within the BWP of the specific cell scheduled via the MC-DCI may be transmitted based on a DFTS-OFDM waveform, and when the value of the field is 1, the PUSCH within the BWP of the specific cell scheduled via the MC-DCI may be transmitted based on a CP-OFDM waveform. The definition of each bit value of the field may be reversed so that, when the value is 1, PUSCH transmission may be performed based on a DFTS-OFDM waveform, and when the value is 0, PUSCH transmission may be performed based on a CP-OFDM waveform.

### [Method 4]

The UE may expect that one PUSCH waveform change indicator field having a length of 1 bit or more is included in MC-DCI, and each codepoint of the PUSCH waveform change indicator field may indicate waveform change information for each cell which may be scheduled via the MC-DCI. The PUSCH waveform change indicator field may have a bit length corresponding to the maximum number of cells which may be scheduled via the MC-DCI. If, within a cell in which the MC-DCI may be received, the UE has reported that the number of cell sets which may be scheduled via the MC-DCI is two or more, or two or more cell sets which may be scheduled via the MC-DCI are configured, the UE may determine the length of the PUSCH waveform change indicator field to be the number of cells included in a cell set having the largest number of cells among multiple cell sets. If a first cell set includes 3 cells and a second cell set includes 4 cells, a 4-bit PUSCH waveform change indicator may be included in the MC-DCI. Since the maximum number of cells that may be included in a specific cell set is 4, the PUSCH waveform change indicator field in the MC-DCI may have a length of up to 4 bits according to this method.

For the PUSCH waveform change indicator having the bit length above included in the MC-DCI, 1 bit is applied to each cell in the form of a bitmap, and each 1 bit applied to each cell may determine the waveform of the PUSCH scheduled in the corresponding cell. In this case, as described above, when the value of the bit (or bit position) corresponding to the specific cell in the PUSCH waveform change indicator within the MC-DCI is 0, the PUSCH within the BWP of the specific cell scheduled via the MC-DCI may be transmitted based on a DFTS-OFDM waveform, and when the value of the bit (or bit position) corresponding to the specific cell is 1, the PUSCH within the BWP of the specific cell scheduled via the MC-DCI may be transmitted based on a CP-OFDM waveform. The definition of each bit value of the field may be reversed so that, when the value is 1, PUSCH transmission may be performed based on a DFTS-OFDM waveform, and when the value is 0, PUSCH transmission may be performed based on a CP-OFDM waveform.

### [Method 5]

The UE may expect that multiple PUSCH waveform change indicator fields each having a length of 1 bit are included in MC-DCI, and each PUSCH waveform change indicator field may include waveform change information for each cell which may be scheduled via the MC-DCI. The number of the PUSCH waveform change indicator fields may be equal to the maximum number of cells which may be scheduled via the MC-DCI. If, within a cell in which the MC-DCI may be received, the UE has reported that the number of cell sets which may be scheduled via the MC-DCI is two or more, or two or more cell sets which may be scheduled via the MC-DCI are configured, the UE may determine the number of the PUSCH waveform change indicator fields to be the number of cells included in a cell set having the largest number of cells among multiple cell sets. If a first cell set includes 3 cells and a second cell set includes 4 cells, the UE may include 4 PUSCH waveform change indicator fields in the MC-DCI, and the length of one field may be 1 bit as described above. Since the maximum number of cells that may be included in a specific cell set is 4, the PUSCH waveform change indicator field in the MC-DCI may have a length of up to 4 bits according to this method. In this case, as described above, when a value of a PUSCH waveform change indicator is 0, a PUSCH within a BWP of a specific cell corresponding to the field scheduled via the MC-DCI may be transmitted based on a DFTS-OFDM waveform, and when the value of the field is 1, a PUSCH within a BWP of a specific cell corresponding to the field scheduled via the MC-DCI may be transmitted based on a CP-OFDM waveform. The definition of each bit value of the field may be reversed so that, when the value is 1, PUSCH transmission may be performed based on a DFTS-OFDM waveform, and when the value is 0, PUSCH transmission may be performed based on a CP-OFDM waveform.

### [Method 6]

By the base station, at least one of [method 1] to [method 5] or any combination thereof may be configured for the UE via higher-layer signaling, enabled for the UE via MAC-CE, indicated to the UE via L1 signaling, or notified to the UE via at least one of higher-layer signaling, MAC-CE, and L1 signaling or any combination thereof. Alternatively, at least one of [method 1] to [method 5] or any combination thereof may be fixedly defined in the specification so as to be used. For example, the UE may be notified, via higher-layer signaling by the base station, of a format of the PUSCH waveform change indicator field in MC-DCI according to one of [method 1] and [method 5]. [Method 1] is a simplest indication method of indicating the same information to all cells while having the smallest overhead, whereas [method 5] is a method capable of indicating individual information for each cell while having the largest overhead. Therefore, for one of the two methods, the base station may indicate a format of the PUSCH waveform change indicator field to the UE via higher-layer signaling depending on a situation. This may use a method similar to that for an antenna port field and a TPMI field which may be affected by a PUSCH waveform, wherein the antenna port field and the TPMI field may be defined as a single field also via higher-layer signaling from the base station so that common information is applied to all cells which may be scheduled via MC-DCI (similar to the [method 1]), or may be defined as multiple individual fields so that individual information is applied to each cell which may be scheduled via MC-DCI (similar to the [method 5]).

The UE may report, to the base station, a UE capability indicating that the UE is capable of supporting at least one of [method 1] to [method 6] or any combination thereof. The UE capability may be defined separately for each of [method 1] to [method 6], or may be defined as a single UE capability indicating that at least one of [method 1] to [method 6] or any combination thereof is supportable. In addition, when the UE cannot support at least one of [method 1] to [method 6] or any combination thereof, the UE may support at least one of [method 1] to [method 6] or any combination thereof by using an alternative scheme. For example, when the UE reports a UE capability indicating that [method 5] is unsupportable, or does not report a UE capability indicating that [method 5] is supportable, the same effect as that for having transferred to the base station that the UE is capable of supporting [method 1] may be obtained.

In [method 1] to [method 6], two types of waveforms, CP-OFDM and DFTS-OFDM, have been described as examples of a PUSCH waveform that may be determined via a PUSCH waveform change indicator, but the disclosure is not limited thereto. In other words, one of three or more types of waveforms may be selected and applied to PUSCH transmission in a cell which may be scheduled via MC-DCI. When three or more types of waveforms are considered, at least of waveforms, such as filter-bank multi-carrier (FBMC), generalized frequency domain multiplexing (GFDM), or filtered-OFDM (F-OFDM), may be considered in addition to CP-OFDM and DFTS-OFDM.

### Embodiment 4: Method for Reducing Overhead of MC-DCI

In an embodiment of the disclosure, described is a method for reducing overhead of MC-DCI when a UE is capable of receiving, via the MC-DCI, scheduling for PUSCH transmission consisting of 2 CWs in a specific cell and, at the same time, receives a waveform change indicator via the MC-DCI in the specific cell to receive a PUSCH based on one waveform among DFTS-OFDM and CP-OFDM. The embodiment may be implemented in combination with other embodiments.

If a UE is equipped with 8 transmission antennas and receives, from a base station via MC-DCI, scheduling information for PUSCH transmission including up to 8 layers, and if the number of cells which may be scheduled via the MC-DCI is 4, the UE may expect that a total of 8 MCS fields, 8 RV fields, and 8 NDI fields are included in the MC-DCI as described above. At the same time, if the UE receives a waveform change indicator via the MC-DCI as described above, the UE may determine a waveform to be used for PUSCH transmission in each cell which may be scheduled via the MC-DCI. When the UE operates in an area where coverage of a specific cell is poor, a waveform change indicator may be used to enable the base station to schedule DFTS-OFDM-based PUSCH transmission, in which case, the DFTS-OFDM-based PUSCH may include up to one layer. Conversely, if the UE is to achieve high throughput in an area where coverage of a specific cell is good, the base station may use a waveform change indicator to schedule CP-OFDM-based PUSCH transmission, in which case, the CP-OFDM-based PUSCH may include up to 8 layers.

Therefore, if the UE is capable of receiving a waveform change indicator via the MC-DCI and receiving scheduling for up to 8 layers for CP-OFDM, the UE may need to be prepared, for each cell, for PUSCH transmission ranging from DFTS-OFDM-based PUSCH transmission which includes one layer and requires relatively little DCI overhead and to CP-OFDM-based PUSCH transmission which may include up to 8 layers and require relatively large DCI overhead. Accordingly, if the UE operates in an area where coverage of a specific cell is poor, and when the UE receives scheduling for DFTS-OFDM-based PUSCH via the MC-DCI, the UE may expect, according to a parameter configured via higher-layer signaling by the base station, a field combination within the MC-DCI allowing preparation for the possibility of scheduling up to 8-layer PUSCH based on CP-OFDM, and this may cause unnecessary DCI overhead.

For example, the MCS, RV, and NDI fields in the MC-DCI are examined. If the UE is scheduled, via the MC-DCI, for DFTS-OFDM-based PUSCH transmission in all 4 cells which may be scheduled via the MC-DCI, fields actually used for DFTS-OFDM-based PUSCH transmission among fields in the MC-DCI are 4 MCS fields, 4 RV fields, and 4 NDI fields, and therefore up to 32 bits are required. In contrast, for CP-OFDM-based PUSCH transmission including up to 8 layers, fields that the UE needs to decode when receiving the DCI may be 64 bits, which are two times the fields above, with a total of 8 MCS fields, a total of 8 RV fields, and a total of 8 NDI fields.

In addition, if the UE is scheduled for DFTS-OFDM-based PUSCH, the UE may be configured, depending on a higher-layer signaling condition, with 2 to 4 bits per cell or over all cells for the antenna port field, 1 to 5 bits per cell or over all cells for the TPMI field, and 0 bit for the PTRS-DMRS association field and the DMRS sequence initialization field, whereas if the UE is scheduled for CP-OFDM-based PUSCH, the UE may be configured, depending on a higher-layer signaling condition, with 3 to 5 bits per cell or over all cells for the antenna port field, 1 to 6 bits per cell or over all cells for the TPMI field, 2 bits per cell or over all cells for the PTRS-DMRS association field, and 1 bit over all cells for the DMRS sequence initialization field. Therefore, when considering the antenna port field, TPMI field, PTRS-DMRS association field, and DMRS sequence initialization field in the MC-DCI, a minimum of 3 bits to a maximum of 46 bits may be required for DFTS-OFDM-based PUSCH, and a minimum of 7 bits to a maximum of 53 bits may be required for CP-OFDM-based PUSCH, so that the maximum difference between the two waveforms may be 50 bits.

Therefore, when considering all the fields in the MC-DCI (e.g., the MCS field, the RV field, the NDI field, the antenna port field, the TPMI field, the PTRS-DMRS association field, the DMRS sequence initialization field, etc.), which are affected by the waveform of the PUSCH which may be scheduled via the MC-DCI, the UE may receive dynamic switching and corresponding scheduling for DFTS-OFDM-based PUSCH and CP-OFDM-based PUSCH including up to 8 layers, by additionally considering up to 32+50=82 bits compared to reception of scheduling in consideration of only DFTS-OFDM-based PUSCH. Accordingly, the UE should be able to prepare for the possibility of PUSCH transmission scheduling of both waveforms before receiving the MC-DCI. Such a large difference in the number of bits may be highly inefficient, may affect a coding rate of a PDCCH, and may affect DCI reception performance in the UE. Therefore, when the UE is capable of receiving a waveform change indicator via MC-DCI, and receiving scheduling of CP-OFDM-based PUSCH including up to 8 layers, the UE and the base station may consider at least one of the following methods or any combination thereof in order to reduce overhead of the MC-DCI.

### [Method 1]

In order to reduce overhead of MC-DCI, a length of each FDRA field corresponding to each cell which may be scheduled via the MC-DCI may be represented as A1+A2 bits, and the bit length of the FDRA field may be adjusted to be smaller than that of FDRA type 0, 1, or 2. An AI value may be up to 6 bits, and for example, some or all of a total of 53 RB lengths shown in Table 28 below may be indicated via an index indicated by 6 bits (or fewer bits). In this case, the lengths (or numbers) of RBs shown in the columns 5 and 10 of Table 28 below indicate multiples of 2^{A}3^{B}5^{C} that are smaller than 275 (where A shown in columns 2 and 7, B shown in columns 3 and 8, and C shown in columns 4 and 9 of Table 28 may be non-negative integers). The reason for being able to indicate only 53 RB values to the UE via the FDRA field is that frequency resource allocation for DFTS-OFDM-based PUSCH is possible only for the number of consecutive RBs corresponding to the multiples of 2^{A}3^{B}5^{C}, and the numbers of RBs below are all applicable to CP-OFDM-based PUSCH.

TABLE 28

| Index | A | B | C | # RBs |
|---|---|---|---|---|
| 0 | 0 | 0 | 0 | 1 |
| 1 | 1 | 0 | 0 | 2 |
| 2 | 0 | 1 | 0 | 3 |
| 3 | 2 | 0 | 0 | 4 |
| 4 | 0 | 0 | 1 | 5 |
| 5 | 1 | 1 | 0 | 6 |
| 6 | 3 | 0 | 0 | 8 |
| 7 | 0 | 2 | 0 | 9 |
| 8 | 1 | 0 | 1 | 10 |
| 9 | 2 | 1 | 0 | 12 |
| 10 | 0 | 1 | 1 | 15 |
| 11 | 4 | 0 | 0 | 16 |
| 12 | 1 | 2 | 0 | 18 |
| 13 | 2 | 0 | 1 | 20 |
| 14 | 3 | 1 | 0 | 24 |
| 15 | 0 | 0 | 2 | 25 |
| 16 | 0 | 3 | 0 | 27 |
| 17 | 1 | 1 | 1 | 30 |
| 18 | 5 | 0 | 0 | 32 |
| 19 | 2 | 2 | 0 | 36 |
| 20 | 3 | 0 | 1 | 40 |
| 21 | 0 | 2 | 1 | 45 |
| 22 | 4 | 1 | 0 | 48 |
| 23 | 1 | 0 | 2 | 50 |
| 24 | 1 | 3 | 0 | 54 |
| 25 | 2 | 1 | 1 | 60 |
| 26 | 6 | 0 | 0 | 64 |
| 27 | 3 | 2 | 0 | 72 |
| 28 | 0 | 1 | 2 | 75 |
| 29 | 4 | 0 | 1 | 80 |
| 30 | 0 | 4 | 0 | 81 |
| 31 | 1 | 2 | 1 | 90 |
| 32 | 5 | 1 | 0 | 96 |
| 33 | 2 | 0 | 2 | 100 |
| 34 | 2 | 3 | 0 | 108 |
| 35 | 3 | 1 | 1 | 120 |
| 36 | 0 | 0 | 3 | 125 |
| 37 | 7 | 0 | 0 | 128 |
| 38 | 0 | 3 | 1 | 135 |
| 39 | 4 | 2 | 0 | 144 |
| 40 | 1 | 1 | 2 | 150 |
| 41 | 5 | 0 | 1 | 160 |
| 42 | 1 | 4 | 0 | 162 |
| 43 | 2 | 2 | 1 | 180 |
| 44 | 6 | 1 | 0 | 192 |
| 45 | 3 | 0 | 2 | 200 |
| 46 | 3 | 3 | 0 | 216 |
| 47 | 0 | 2 | 2 | 225 |
| 48 | 4 | 1 | 1 | 240 |
| 49 | 0 | 5 | 0 | 243 |
| 50 | 1 | 0 | 3 | 250 |
| 51 | 8 | 0 | 0 | 256 |
| 52 | 1 | 3 | 1 | 270 |

The A2 bits may be determined to indicate a starting point of PUSCH frequency resource allocation information including consecutive RBs, the information being indicated by the AI bits. For example, A2 may be defined as 0 (that is, the A2 bits are not included in the FDRA field and only the AI bits are included), or a value of the A2 bits may be determined to a predetermined value (e.g., 0). In this case, a starting position of a PUSCH frequency resource may always start from a first RB of a bandwidth part, a starting RB position may be determined so that a PUSCH is located at the center of the bandwidth part, or the starting position may be configured via higher-layer signaling. In this case, if the UE is configured with the starting RB position of the PUSCH frequency resource via higher-layer signaling, corresponding configuration information may be expressed in units of 1, 2, or 4 RBs or expressed in units of RB of a larger value.

In another example, A2 may be used to indicate a starting RB position of PUSCH frequency resource allocation expressed in units of N RBs, and for example, if the maximum RB size of a bandwidth part that may be configured for the UE is 275 RBs, A2 may be ceil (log 2(275/N)), where ceil(.) denotes a ceiling function and log 2(.) denotes a logarithmic function with a base of 2. If N is 8, AI may be 6 bits. The UE may be configured with a value of N via higher-layer signaling by the base station, or a value of N may be fixedly defined in the specification. In summary, the A1+A2 bits determined using the method above may be smaller than a maximum of 18 bits for FDRA type 0 having an RBG size of 4 or than a maximum of 16 bits for FDRA type 1, so that overhead of the MC-DCI can be reduced.

### [Method 2]

In order to reduce overhead of MC-DCI, the UE and the gNB may impose a restriction on the FDRA field corresponding to each cell which may be scheduled via the MC-DCI. It is assumed that the UE is equipped with 8 transmission antennas and may receive, via the MC-DCI, scheduling for CP-OFDM-based PUSCH including up to 8 layers as described above, and/or dynamic switching to one of DFTS-OFDM-based PUSCH and CP-OFDM-based PUSCH is possible via a waveform change indicator in the MC-DCI. In this case, an FDRA indication type of the FDRA field corresponding to each cell which may be scheduled via the MC-DCI may be restricted to bitmap-based FDRA type 0, and at the same time, an RBG size expressed by each bit of the FDRA field defined based on FDRA type 0 may be additionally defined.

For example, the UE may be notified, via higher-layer signaling by the base station, of one of three types of configuration information as shown in Table 29 below, and may determine an RBG size of each bit indicated via FDRA type 0 according to a size of a bandwidth part for each configuration information. In Table 29 below, for example, when the UE has been configured with configuration 3, and a size of an active bandwidth part of the UE is 50 RBs, the UE may consider 16 RBs as an RBG size to be used for FDRA type 0. In this manner, when the UE has been configured with configuration 3 via higher-layer signaling by the base station, a size of one RBG may be up to 4 times that of configuration 1 or up to 2 times that of configuration 2, and thus the bit length of the FDRA field may be reduced to a maximum of one-quarter or one-half, thereby reducing overhead of the MC-DCI.

TABLE 29

| RB size of | | | |
|---|---|---|---|
| bandwidth part | Configuration 1 | Configuration 2 | Configuration 3 |
| 1-36 | 2 | 4 | 8 |
| 37-72 | 4 | 8 | 16 |
| 73-144 | 8 | 16 | 32 |
| 145-275 | 16 | 16 | 32 |

### [Method 3]

In order to reduce overhead of MC-DCI, the UE and the gNB may impose another restriction on the FDRA field corresponding to each cell which may be scheduled via the MC-DCI. It is assumed that the UE is equipped with 8 transmission antennas and may receive, via the MC-DCI, scheduling for CP-OFDM-based PUSCH including up to 8 layers as described above, and/or at the same time, dynamic switching to one of DFTS-OFDM-based PUSCH and CP-OFDM-based PUSCH is possible via a waveform change indicator in the MC-DCI. In this case, an FDRA indication type of the FDRA field corresponding to each cell which may be scheduled via the MC-DCI may be restricted to FDRA type 1. In addition, when considering a start and length indicator value (SLIV) defined based on conventional FDRA type 1, both starting position and length are considered in units of a single RB, but in the case of restricted FDRA type 1, both starting position and length may be considered in units of N RBs. In this case, the UE may be configured with units of N RBs via higher-layer signaling by the base station, where N may be, for example, 1, 2, 4, 8, or another value. Alternatively, a value of N may be predetermined, or it is possible to use a predetermined value depending on a size of a bandwidth part. In this manner, if the base station and the UE use an SLIV for starting position and length defined using units of N RBs, an effect similar to that of using an SLIV defined with starting position and length in units of a single RB may be achieved while reducing an RB size of a bandwidth part. That is, when considering the same size of bandwidth part, codepoints expressible by SLIV decrease, and the bit length of the FDRA field may be thus reduced, thereby reducing overhead of the MC-DCI.

### [Method 4]

The UE and the base station may consider a method of using different FDRA-related configurations for CP-OFDM-based PUSCH transmission and DFTS-OFDM-based PUSCH. If the UE is equipped with 8 transmission antennas and can be scheduled, via MC-DCI, for CP-OFDM-based PUSCH including up to 8 layers, and/or dynamic switching to one of DFTS-OFDM-based PUSCH and CP-OFDM-based PUSCH is possible via a waveform change indicator in the MC-DCI, the UE may expect to receive configuration information for an FDRA type for each of CP-OFDM and DFTS-OFDM from the base station.

The UE may be configured with a different FDRA type for each waveform. For example, for each cell which may be scheduled via the MC-DCI, the UE may be configured with FDRA type 1 for CP-OFDM-based PUSCH via higher-layer signaling by the base station, and may transmit FDRA type 1-based PUSCH by being configured, via higher-layer signaling, with an RB granularity unit to be considered for SLIV (for example, based on the [method 3]). For DFTS-OFDM-based PUSCH scheduled via the MC-DCI, the UE may be configured with FDRA type 0 via higher-layer signaling by the base station, may be configured with an RBG size via higher-layer signaling by the base station, and may transmit FDRA type 0-based PUSCH. In this case, a FDRA field length for a specific cell which may be scheduled via the MC-DCI may be defined according to a larger value between a bit length corresponding to FDRA-related configuration information for the CP-OFDM-based PUSCH and a bit length corresponding to FDRA-related configuration information for the DFTS-OFDM-based PUSCH.

Alternatively, the UE may be configured with a common FDRA type for both waveforms, and may be configured with each of the two waveforms via additional higher-layer signaling required for the FDRA type. For example, for each cell which may be scheduled via the MC-DCI, the UE may be configured with the same FDRA type 0 for both CP-OFDM-based PUSCH and DFTS-OFDM-based PUSCH, and for example, the UE may be configured with configuration 3 in Table 29 via higher-layer signaling by the base station for the CP-OFDM-based PUSCH and may be configured with configuration 2 in Table 29 via higher-layer signaling by the base station for the DFTS-OFDM-based PUSCH. In this case, for the DFTS-OFDM-based PUSCH, only scheduling for consecutive RBs may be possible even for the FDRA type 0. In this case, a FDRA field length for a specific cell which may be scheduled via the MC-DCI may be defined according to a larger value between a bit length corresponding to FDRA-related configuration information for the CP-OFDM-based PUSCH and a bit length corresponding to FDRA-related configuration information for the DFTS-OFDM-based PUSCH.

The method above may be advantageous in reducing overhead of the MC-DCI while securing scheduling flexibility supportable via each waveform when performing PUSCH transmission based on two different waveforms of DFTS-OFDM and CP-OFDM. For example, for the DFTS-OFDM-based PUSCH, only scheduling for RBs which are consecutive RBs and correspond to multiples of 2^{A}3^{B}5^{C} (where A, B, and C may be integers not smaller than 0), but for the CP-OFDM-based PUSCH, scheduling is possible for both consecutive and non-consecutive RBs and may not be restricted to the number of RBs corresponding to a multiple of a specific value as in the DFTS-OFDM-based PUSCH.

### [Method 5]

The UE and the base station may restrict a bit length of an FDRA field to reduce overhead of MC-DCI. It is assumed that the UE is equipped with 8 transmission antennas and may receive, via MC-DCI, scheduling for CP-OFDM-based PUSCH including up to 8 layers as described above, and/or dynamic switching to one of DFTS-OFDM-based PUSCH and CP-OFDM-based PUSCH is possible via a waveform change indicator in the MC-DCI. In this case, the UE may be configured, via higher-layer signaling by the base station, with a bit length to be reduced for the FDRA field for each cell which may be scheduled via the MC-DCI.

Corresponding higher-layer signaling configuration information may be configured separately for each cell which may be scheduled via the MC-DCI or may be configured commonly for all cells. For example, if the UE is configured with FDRA type 0 for both two cells which may be scheduled via the MC-DCI, the UE may be configured, via higher-layer signaling by the base station, that bit lengths of the FDRA field are reduced by 3 bits and 5 bits for a first cell and a second cell, respectively. In this case, the UE may interpret the field with a field length before reduction and may consider all bits corresponding to the reduced length to be 0.

As another method, the UE may redefine the meaning of each codepoint of the FDRA field to correspond to the reduced field length. For example, for each cell which may be scheduled via the MC-DCI, if the UE is configured with FDRA type 0 for the FDRA field, the UE may determine a position of RBG corresponding to the reduced number of bits, and PUSCH frequency resource allocation may not be possible for the RBG at the corresponding position. In this case, the RBG for which frequency resource allocation is not possible may be located from a starting RB of an uplink bandwidth part or from an ending RB, or may be divided and located at both the starting RB and the ending RB of the uplink bandwidth part so as to enable PUSCH to be allocated at the center of the uplink bandwidth part when PUSCH frequency resource allocation is performed based on the FDRA field with the reduced length. For example, if the reduced number of bits is an odd number such as 3, an RBG corresponding to two bits (or one bit) may be located from the starting RB of the uplink bandwidth part, and an RBG corresponding to one bit (or two bits) may be located from the ending RB of the uplink bandwidth part. That is, in this case, PUSCH frequency resource allocation cannot be performed via the FDRA field for two consecutive RBGs including the starting RB of the uplink bandwidth part and for one RBG including the ending RB of the uplink bandwidth part.

In this manner, when the method for reducing the bit length of the FDRA field is used, although flexibility for PUSCH frequency resource allocation may be reduced, DCI payload overhead of the MC-DCI can be reduced. The UE and the base station may also apply this scheme to another field in the MC-DCI other than the FDRA. For example, the UE may similarly use a scheme of restricting a bit length also for a TPMI field and an antenna port field.

### [Method 6]

The UE and the base station may introduce a restriction on formats of a TPMI field and an antenna port field within MC-DCI to reduce overhead of the MC-DCI. As described above, the UE may be configured with one of the following two field formats via higher-layer signaling by the base station.
The UE may expect that one TPMI field and one antenna port field exist in the MC-DCI, and may expect that the one TPMI field and the one antenna port field are commonly applied to PUSCHs of all cells which may be scheduled via the MC-DCI. In this case, among lengths of TPMI fields and antenna port fields, which are required for respective cells and determined according to higher-layer signaling for the respective cells which may be scheduled via the MC-DCI, the UE may determine a largest TPMI field length as a size of one TPMI field existing in the MC-DCI and may determine a largest antenna port field length as a size of one antenna port field existing in the MC-DCI.
The UE may expect that TPMI fields and antenna port fields corresponding to respective cells which may be scheduled via the MC-DCI exist independently.

It is assumed that the UE is equipped with 8 transmission antennas and may receive, via MC-DCI, scheduling for CP-OFDM-based PUSCH including up to 8 layers as described above, and/or dynamic switching to one of DFTS-OFDM-based PUSCH and CP-OFDM-based PUSCH is possible via a waveform change indicator in the MC-DCI. In this case, the UE may expect that the TPMI field and the antenna port field existing in the MC-DCI correspond to the first field format among the two field formats. Alternatively/additionally, the UE may receive the same higher-layer signaling configuration for each cell which may be scheduled via the MC-DCI, and the lengths of the TPMI and antenna port fields required for each cell may be restricted to be equal for all cells.

When this restriction is used, the UE may expect that only one TPMI field and one antenna port field exist in the MC-DCI, and may commonly apply each one field to all cells which may be scheduled via the MC-DCI, thereby reducing overhead of the MC-DCI.

### [Method 7]

The UE and the base station may introduce a restriction on a PTRS-DMRS association field within MC-DCI to reduce overhead of the MC-DCI. It is assumed that the UE is equipped with 8 transmission antennas and may receive, via MC-DCI, scheduling for CP-OFDM-based PUSCH including up to 8 layers as described above, and/or dynamic switching to one of DFTS-OFDM-based PUSCH and CP-OFDM-based PUSCH is possible via a waveform change indicator in the MC-DCI. In this case, the UE may expect that no PTRS-DMRS association field exists in the MC-DCI. That is, the UE capable of dynamic switching between CP-OFDM-based PUSCH and DFTS-OFDM-based PUSCH including up to 8 layers via the MC-DCI as described above may be configured, via higher-layer signaling by the base station, that uplink PTRS transmission is not possible. Based on this, the UE may achieve overhead reduction of at least 8 bits (a minimum of 2 bits per cell for a total of 4 cells is considered) due to a PTRS-DMRS association field that may exist for each cell which may be scheduled via the MC-DCI.

### [Method 8]

By the base station, at least one of [method 1] to [method 7] or any combination thereof may be configured for the UE via higher-layer signaling so as to be performed, enabled for the UE via MAC-CE, indicated to the UE via L1 signaling, or notified to the UE via at least one of higher-layer signaling, MAC-CE, and L1 signaling or any combination thereof. Alternatively, at least one of [method 1] to [method 4] or any combination thereof may be fixedly defined in the specification so as to be used.

For example, the UE may be notified, via higher-layer signaling by the base station, of a scheme for reducing payload overhead of the MC-DCI according to one of [method 1] to [method 7]. [Method 1] to [method 5] are all related to an FDRA field in MC-DCI, and for an overhead controlling method using an FDRA field, the UE may be configured with at least one of the 5 methods via higher-layer signaling.

As another example, the UE may combine and use at least one of [method 1] to [method 5] and at least one of [method 6] and [method 7]. [Method 1] to [method 5] are overhead reduction schemes for an FDRA field, [method 5] may also be applicable to a field other than the FDRA field, and [method 6] and [method 7] are applicable to a TPMI field, an antenna port field, and a PTRS-DMRS association field. Therefore, according to at least one of these methods or any combination thereof, the UE and the base station may individually apply each method to applicable fields so as to reduce overhead of the MC-DCI.

The UE may report, to the base station, a UE capability indicating that the UE is capable of supporting at least one of [method 1] to [method 8] or any combination thereof. The UE capability may be defined separately for each of [method 1] to [method 8], or may be defined as a single UE capability indicating that at least one of [method 1] to [method 8] or any combination thereof is supportable. In addition, when the UE cannot support at least one of [method 1] to [method 8] or any combination thereof, the UE may support at least one of [method 1] to [method 8] or any combination thereof by using an alternative scheme. For example, when the UE reports a UE capability indicating that [method 1] is unsupportable, or does not report a UE capability indicating that [method 1] is supportable, the same effect as that for having transferred to the base station that the UE is capable of supporting [method 5] may be obtained.

In [method 1] to [method 8], two types of waveforms, CP-OFDM and DFTS-OFDM, have been described as examples of a PUSCH waveform that may be determined via a PUSCH waveform change indicator, but the disclosure is not limited thereto. In other words, one of three or more types of waveforms may be selected and applied to PUSCH transmission in a cell which may be scheduled via MC-DCI. When three or more types of waveforms are considered, at least of waveforms, such as filter-bank multi-carrier (FBMC), generalized frequency domain multiplexing (GFDM), or filtered-OFDM (F-OFDM), may be considered in addition to CP-OFDM and DFTS-OFDM.

Although the effect of reducing DCI payload overhead may be smaller than that of the MC-DCI, the UE and the base station may apply at least one of [method 1] to [method 8] or any combination thereof to not only the MC-DCI but also DCI formats 0_1 or 0_2. To this end, the UE may report a relevant UE capability to the base station, and the base station may configure higher-layer signaling accordingly, thereby allowing use of the DCI payload overhead reduction scheme also for DCI formats 0_1 and 0_2.

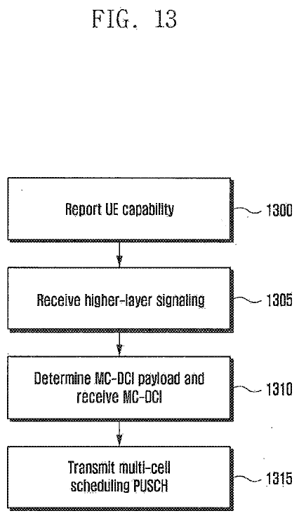

FIG. 13 is a diagram illustrating an operation of a UE according to an embodiment of the disclosure.

A UE may report 1300 a UE capability to a base station. In this case, the UE capability that the UE may report to the base station may include at least one of the number of cell sets which may be scheduled via MC-DCI, the maximum number of cells per cell set, whether to support at least one of [method 1] to [method 6] or any combination thereof in embodiment 3 related to the dynamic switching scheme of PUSCH transmission waveforms via the MC-DCI, and whether to support at least one of [method 1] to [method 8] or any combination thereof in embodiment 4 related to the overhead reduction scheme of the MC-DCI.

The UE may receive 1305 higher-layer signaling from the base station. In this case, the higher-layer signaling that the UE may receive from the base station may include at least one of one or more cell indexes included in each of one or more cell sets, a table including cell scheduling information in each cell set which may be scheduled via the MC-DCI, information according to at least one of [method 2-1] to [method 2-6] or any combination thereof related to the dynamic switching scheme of PUSCH transmission waveforms via the MC-DCI, and information according to at least one of [method 4-1] to [method 4-8] or any combination thereof related to the overhead reduction scheme of the MC-DCI. The aforementioned information may be received concurrently from the base station or received at different times.

The UE may determine a payload size of the MC-DCI based on the signaling in operations 1300 and 1305, and may receive 1310 the MC-DCI from the base station based on the determined payload size of the MC-DCI. In this case, the MC-DCI may include at least one of a cell set indicator field, a scheduling cell indicator field, one or more TDRA fields, and one or more FDRA fields, and according to at least one embodiment of the disclosure, L1 signaling according to at least one of [method 1] to [method 6] in embodiment 3 or any combination thereof (related to the PUSCH transmission waveform switching indicator via the MC-DCI) and L1 signaling according to at least one of [method 1] to [method 8] in embodiment 4 or any combination thereof (related to the overhead reduction scheme of the MC-DCI) may be included.

The UE may perform 1315 PUSCH transmission for multiple cells based on scheduling information in the MC-DCI received from the base station. Specifically, according to at least one embodiment of the disclosure, the UE may perform PUSCH transmission on each cell via higher-layer signaling and/or Li signaling (or one or more pieces of information or fields) included in the MC-DCI based on at least one of [method 1] to [method 6] in embodiment 3 or any combination thereof (related to the PUSCH transmission waveform switching indicator via the MC-DCI) and via higher-layer signaling and/or L1 signaling (or one or more pieces of information or fields) included in the MC-DCI based on at least one of [method 1] to [method 8] in embodiment 4 or any combination thereof (related to the overhead reduction scheme of the MC-DCI).

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, the operations may be omitted or replaced by other operations.

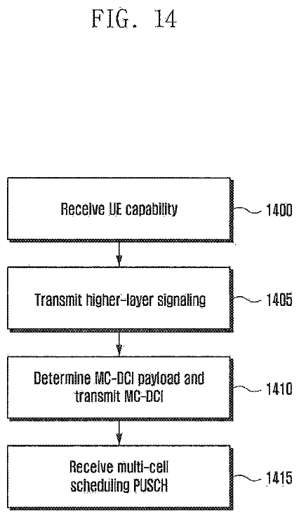

FIG. 14 is a diagram illustrating an operation of a base station according to an embodiment of the disclosure.

A base station may receive 1400 a UE capability from a UE. Specifically, the UE capability that the base station may receive from the UE may include at least one of the number of cell sets which may be scheduled via MC-DCI, the maximum number of cells per cell set, whether to support at least one of [method 1] to [method 6] or any combination thereof in embodiment 3 related to the dynamic switching scheme of PUSCH transmission waveforms via the MC-DCI, and whether to support at least one of [method 1] to [method 8] or any combination thereof in embodiment 4 related to the overhead reduction scheme of the MC-DCI.

The base station may transmit 1405 higher-layer signaling to the UE. In this case, the higher-layer signaling that the base station may transmit to the UE may include at least one of one or more cell indexes included in each of one or more cell sets, a table including cell scheduling information in each cell set which may be scheduled via the MC-DCI, information according to at least one of [method 1] to [method 6] in embodiment 3 or any combination thereof (related to the dynamic switching scheme of PUSCH transmission waveforms via the MC-DCI), and information according to at least one of [method 1] to [method 8] in embodiment 4 or any combination thereof (related to the overhead reduction scheme of the MC-DCI). The aforementioned information may be received concurrently from the base station or received at different times.

The base station may determine a payload size of the MC-DCI based on the signaling in operations 1400 and 1405, and may transmit 1410 the MC-DCI to the UE. In this case, the MC-DCI may include at least one of a cell set indicator field, a scheduling cell indicator field, one or more TDRA fields, and one or more FDRA fields, and according to at least one embodiment of the disclosure, L1 signaling according to at least one of [method 1] to [method 6] in embodiment 3 or any combination thereof (related to the PUSCH transmission waveform switching indicator via the MC-DCI) and L1 signaling according to at least one of [method 1] to [method 8] in embodiment 4 or any combination thereof (related to the overhead reduction scheme of the MC-DCI) may be included.

The base station may receive 1415, from the UE, PUSCH transmission on multiple cells corresponding to the scheduling information in the MC-DCI transmitted to the UE. Specifically, according to at least one embodiment of the disclosure, the base station may receive, on each cell, a PUSCH transmitted from the UE corresponding to higher-layer signaling and/or L1 signaling (or one or more pieces of information or fields) included in the MC-DCI based on at least one of [method 1] to [method 6] in embodiment 3 or any combination thereof (related to the PUSCH transmission waveform switching indicator via the MC-DCI) and corresponding to higher-layer signaling and/or L1 signaling (or one or more pieces of information or fields) included in the MC-DCI based on at least one of [method 1] to [method 8] in embodiment 4 or any combination thereof (related to the overhead reduction scheme of the MC-DCI).

The above-described flowchart illustrates an exemplary method that may be implemented according to the principle of the disclosure, and various changes may be made to the method shown in the flowchart herein. For example, although shown as a series of operations, various operations in each figure may overlap, occur in parallel, occur in a different order, or occur multiple times. In another example, the operations may be omitted or replaced by other operations.

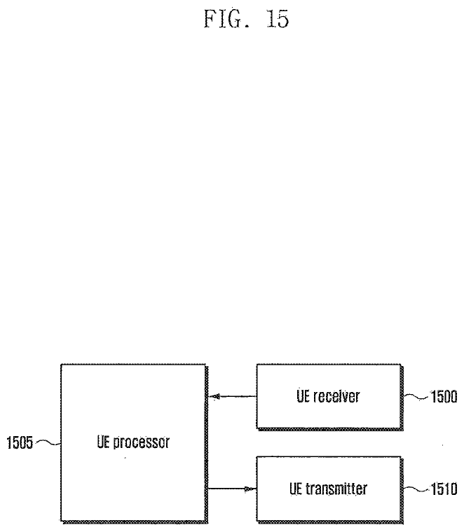

FIG. 15 illustrates a structure of a UE in a wireless communication system according to an embodiment of the disclosure.

Referring to FIG. 15, the UE may include a transceiver, which refers to a UE receiver 1500 and a UE transmitter 1510 as a whole, a memory (not illustrated), and a UE processor 1505 (or UE controller or processor). The UE transceiver 1500 and 1510, the memory, and the UE processor 1505 may operate according to the above-described communication methods of the UE. However, components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with base stations. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

Furthermore, the processor may control a series of processes so that the UE can operate according to the above-described embodiments. For example, the processor may control components of the UE to receive DCI configured in two layers so as to simultaneously receive multiple PDSCHs. The processor may include multiple processors, and the processor may perform the operation of controlling the components of the UE by executing programs stored in the memory.

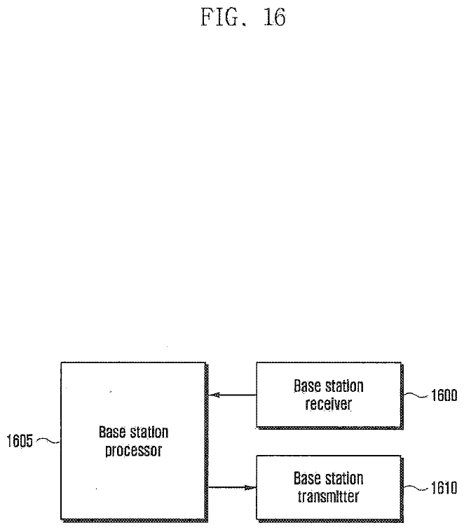

FIG. 16 illustrates a structure of a base station in a wireless communication system according to an embodiment of the disclosure.

Referring to FIG. 16, the base station may include a transceiver, which refers to a base station receiver 1600 and a base station transmitter 1610 as a whole, a memory (not illustrated), and a base station processor 1605 (or base station controller or processor). The base station transceiver 1600 and 1610, the memory, and the base station processor 1605 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

In addition, the transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes so that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, these programs may be stored in memories configured by any combination of some or all of them. In addition, each of the configured memories may include multiple memories.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure.→That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A method performed by a terminal in a communication system, the method comprising:
receiving, from a base station, information for configuring uplink data transmission supporting up to 8 layers;
receiving, from the base station, information for configuring dynamic waveform switching for a physical uplink shared channel (PUSCH);
receiving, from the base station, downlink control information (DCI) for scheduling the uplink data transmission, the DCI comprising scheduling information for the PUSCH and a waveform switching indicator for the PUSCH; and
based on the DCI, transmitting the PUSCH to the base station,
wherein the scheduling information comprises frequency resource allocation information for the PUSCH, and
wherein a value of the frequency resource allocation information indicates one number among multiples of one or more predetermined integers, and as many consecutive resource blocks as a number corresponding to the one number are scheduled.

2. The method of claim 1, wherein the multiples of the one or more predetermined integers are in the form of 2^{A}3^{B}5^{C} having a value smaller than 275, where A, B, and C are non-negative integers.

3. The method of claim 1, wherein the frequency resource allocation information further comprises information indicating a starting point of the consecutive resource blocks.

4. The method of claim 3, wherein the information indicating the starting point of the consecutive resource blocks is ceil (log₂(275/N)) bits, and N is configured via higher-layer signaling.

5. A method performed by a base station in a communication system, the method comprising:
transmitting, to a terminal, information for configuring uplink data transmission supporting up to 8 layers;
transmitting, to the terminal, information for configuring dynamic waveform switching for a physical uplink shared channel (PUSCH);
transmitting, to the terminal, downlink control information (DCI) for scheduling the uplink data transmission, the DCI comprising scheduling information for the PUSCH and a waveform switching indicator for the PUSCH; and
receiving the PUSCH corresponding to the DCI from the terminal,
wherein the scheduling information comprises frequency resource allocation information for the PUSCH, and
wherein a value of the frequency resource allocation information indicates one number among multiples of one or more predetermined integers, and as many consecutive resource blocks as a number corresponding to the one number are scheduled.

6. The method of claim 5, wherein the multiples of the one or more predetermined integers are in the form of 2^{A}3^{B}5^{C} having a value smaller than 275, where A, B, and C are non-negative integers.

7. The method of claim 5, wherein the frequency resource allocation information further comprises information indicating a starting point of the consecutive resource blocks.

8. The method of claim 7, wherein the information indicating the starting point of the consecutive resource blocks is ceil (log₂(275/N)) bits, and N is configured via higher-layer signaling.

9. A terminal in a communication system, the terminal comprising:
a transceiver; and
a controller configured to
receive, from a base station, information for configuring uplink data transmission supporting up to 8 layers,
receive, from the base station, information for configuring dynamic waveform switching for a physical uplink shared channel (PUSCH),
receive, from the base station, downlink control information (DCI) for scheduling the uplink data transmission, the DCI comprising scheduling information for the PUSCH and a waveform switching indicator for the PUSCH, and
based on the DCI, transmit the PUSCH to the base station,
wherein the scheduling information comprises frequency resource allocation information for the PUSCH, and
wherein a value of the frequency resource allocation information indicates one number among multiples of one or more predetermined integers, and as many consecutive resource blocks as a number corresponding to the one number are scheduled.

10. The terminal of claim 9, wherein the multiples of the one or more predetermined integers are in the form of 2^{A}3^{B}5^{C} having a value smaller than 275, where A, B, and C are non-negative integers.

11. The terminal of claim 9, wherein the frequency resource allocation information further comprises information indicating a starting point of the consecutive resource blocks.

12. The terminal of claim 11, wherein the information indicating the starting point of the consecutive resource blocks is ceil (log₂(275/N)) bits, and N is configured via higher-layer signaling.

13. A base station in a communication system, the base station comprising:
a transceiver; and
a controller configured to
transmit, to a terminal, information for configuring uplink data transmission supporting up to 8 layers,
transmit, to the terminal, information for configuring dynamic waveform switching for a physical uplink shared channel (PUSCH),
transmit, to the terminal, downlink control information (DCI) for scheduling the uplink data transmission, the DCI comprising scheduling information for the PUSCH and a waveform switching indicator for the PUSCH, and
receive the PUSCH corresponding to the DCI from the terminal,
wherein the scheduling information comprises frequency resource allocation information for the PUSCH, and
wherein a value of the frequency resource allocation information indicates one number among multiples of one or more predetermined integers, and as many consecutive resource blocks as a number corresponding to the one number are scheduled.

14. The base station of claim 13, wherein the multiples of the one or more predetermined integers are in the form of 2^{A}3^{B}5^{C} having a value smaller than 275, where A, B, and C are non-negative integers.

15. The base station of claim 13, wherein the frequency resource allocation information further comprises information indicating a starting point of the consecutive resource blocks, and
wherein the information indicating the starting point of the consecutive resource blocks is ceil (log₂(275/N)) bits, and N is configured via higher-layer signaling.
